(19) United States
(12) Patent Application Publication
(10) Pub. No.: US 2026/0367457 A1
(43) Pub. Date: Nov. 19, 2026

(54) ELECTROPHORETIC MEDIA COMPRISING CHARGE CONTROL AGENT HAVING AN AMINE OXIDE FUNCTIONAL GROUP AND A HYDROPHOBIC MOIETY

(71) Applicant: E INK CORPORATION, Billerica, MA (US)

(72) Inventor: Eugene BZOWEJ, Dunstable, MA (US)

(21) Appl. No.: 19/651,630

(22) Filed: Apr. 18, 2026

Related U.S. Application Data
(60) Provisional application No. 63/793,395, filed on Apr. 23, 2025.

(51) Int. Cl. G02F 1/167; C08G 63/685; G02F 1/1675; G02F 1/1676

(52) U.S. Cl. CPC G02F 1/167; C08G 63/6852; G02F 1/1676; G02F 2001/1678

(57) ABSTRACT

Electrophoretic media are disclosed containing a plurality of electrically charged pigment particles, a charge control agent, and a non-polar liquid, the charge control agent having at least one amine oxide functional group and at least one hydrophobic moiety.

### RELATED APPLICATIONS

This application claims priority to U.S. Provisional Patent Application No. 63/793,395, filed on Apr. 23, 2025. The entire contents of any patent, published application, or other published work referenced herein is incorporated by reference.

### FIELD OF THE INVENTION

This invention relates to electrophoretic media for electro-optic displays, the electrophoretic media comprising a plurality of electrically charged pigment particles and a charge control agent in a non-polar liquid. The charge control agent has at least one amine oxide functional group and at least one hydrophobic moiety.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Particle-based electrophoretic displays have been the subject of intense research and development for a number of years. In such displays, a plurality of electrically charged pigment particles (also called electrophoretic particles) move through a non-polar liquid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays, however, and electrophoretic displays are typically too slow to display real-time video. Additionally, the electrophoretic displays can be sluggish at low temperatures because the viscosity of the non-polar liquid limits the movement of the electrically charged pigment particles. Despite these shortcomings, electrophoretic displays can be found in everyday products such as electronic books (e-readers), mobile phones and mobile phone covers, smart cards, signs, watches, shelf labels, and flash drives.

The term “gray state” is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays, and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of electrically charged pigment particles move through a non-polar liquid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, electrically charged pigment particles that make up electrophoretic displays tend to settle, resulting in inadequate service-life for these displays.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which comprises an electrophoretic medium containing electrophoretically-mobile electrically charged pigment particles in a non-polar liquid medium, and a capsule wall surrounding the electrophoretic medium. Typically, the capsules are themselves held within a polymeric binder to form a coherent layer positioned between two electrodes. In a microcell electrophoretic display, the electrically charged pigment particles and the non-polar liquid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders, and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Although electrophoretic media are often opaque (since, for example, in many electrophoretic media, the electrically charged pigment particles substantially block transmission of visible light through the display) and operate in a reflective mode, many electrophoretic displays can be made to operate in a so-called “shutter mode” in which one display state is substantially opaque, and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as a first electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

An electro-optic display normally comprises a layer of electro-optic material and at least two other layers disposed on opposed sides of the electro-optic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer (a first electrode layer); a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or maybe a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

An electro-optic display may comprise an electrophoretic medium containing two or more types of electrically charged pigment particles, a charge control agent, and a non-polar liquid. Typically, the two or more electrically charged pigment particles have different electrophoretic mobilities. For example, a black-and-white electro-optic display may comprise an electrophoretic medium containing black electrically charged pigment particles and oppositely charged white electrically charged pigment particles. A full color electro-optic display may comprise an electrophoretic medium containing four types of electrically charged pigment particles, a charge control agent, and a non-polar liquid. For example, U.S. Pat. No. 9,921,451 teaches a colored electro-optic display that includes an electrophoretic medium which comprises (a) one type of light-scattering electrically charged pigment particles (typically white) and (b) three substantially non-light-scattering types of electrically charged pigment particles providing three subtractive primary colors. The use of substantially non-light-scattering particle types having subtractive primary colors allows mixing of colors and provides for more color outcomes at a single pixel. Electrophoretic media of electro-optic displays show complex behaviors, particularly those containing multiple types of charged pigments with varying charges and mobilities. Complicated “waveforms” are needed to drive the electrically charged pigment particles between the various optical states. Compounded with the complexities of the electric fields, the mixture of electrically charged pigment particles, charge control agent, and non-polar liquid can exhibit unexpected behavior because of the interactions between the components of the electrophoretic medium, and the interaction of these components with the encapsulating materials upon application of an electric field. The switching from one optical state to another optical state may be slow. Incomplete separation of the different types of electrically charged pigment particles may result in poor color gamut of the optical states. Complications may arise because of the wide range of temperatures over which such electro-optic displays must operate. For example, outdoor electro-optic displays must operate both at low and high temperatures. Thus, there is a need to develop electro-optic displays having electrophoretic media wherein the switching time between optical states is reduced, the color gamut of the display is improved, and the operation of the corresponding display is not significantly affected by the temperature of operation. The inventor of the present invention surprisingly found that the switching speed between optical states is increased, the achievable color gamut of the display is improved, and the display shows good operation at different temperatures (0 °C and 25 °C), by using an electrophoretic medium comprising a charge control agent, the charge control agent having at least one amine oxide functional group and at least one hydrophobic moiety.

### SUMMARY OF THE INVENTION

In one aspect, the present invention provides an electrophoretic medium comprising a plurality of a first type of electrically charged pigment particles, a plurality of a second type of electrically charged pigment particles, a first charge control agent, and a non-polar liquid. The first charge control agent has at least one amine oxide functional group and at least one hydrophobic moiety. The first type of electrically charge pigment particles has a first color and a first charged polarity. The second type of electrically charge pigment particles has a second color and a second charged polarity. The first color is different from the second color, and the first charge polarity is opposite to the second charge polarity.

The plurality of the first and the plurality of the second type of electrically charged pigment particles are capable of moving through the non-polar liquid upon application of an electric field. The first charge control agent may have a weight average molecular weight that is greater than or equal to 400 g/mol. The first charge control agent may have a weight average molecular weight that is from 400 g/mol to 200,000 g/mol.

The hydrophobic moiety of the first charge control gent may be a polymeric hydrophobic moiety. The at least one hydrophobic moiety of the first charge control agent may be selected from the group consisting of a hydrocarbon group, a polyester, a polythioester, a polyether, a polyamide, a polyurethane, a polyurea, a polyacrylate, a polymethacrylate, a polydimethylsiloxane, a polycarbonate, a polystyrene, a polythiocarbonate, a polylactide, and combinations thereof.

The electrophoretic medium may further comprise a protic acid, the protic having pKa of lower than 5.0, lower than 4.5, or lower than 4.0. The protic may have pKa of from 5.0 to −16, from 5.0 to −5.0, from 4.8 to −12, from 4.6 to −10, from 4.5 to −6.0, from 4.4 to −4.0, from 4.2 to −3.0, from 4.1 to −1.0, or from 4.0 to 0.

The first charge control agent may be selected from the group consisting of a branched polyethylenimine derivative, a compound that is represented by Formula III, a compound that is represented by Formula III, a compound that is represented by Formula IV, a compound that is represented by Formula V, a compound that is represented by Formula VI, a compound that is represented by Formula VII, a compound that is represented by Formula VIII, a compound that is represented by Formula IX, a compound that is represented by Formula X, a compound that is represented by Formula XI, a compound that is represented by Formula XII, a compound that is represented by Formula XIII, a compound that is represented by Formula XIV, a compound that is represented by Formula XV, a compound that is represented by and Formula XVI, and combinations thereof.

The branched polyethylenimine derivative has at least one amine oxide functional group and at least one hydrophobic moiety. The branched polyethylenimine derivative may be formed from a branched polyethylenimine by a first reaction, a second reaction, and a third reaction. The branched polyethylenimine has a plurality of primary amine functional groups, a plurality of secondary functional groups, and a plurality of tertiary amine functional groups. Each primary amine functional group of the plurality of primary amine functional groups has a primary amine nitrogen atom. Each secondary amine functional group of the plurality of secondary amine functional groups has a secondary amine nitrogen atom. Each tertiary amine functional group of the plurality of tertiary amine functional groups has a tertiary amine nitrogen atom.

The first reaction occurs between a first reagent and at least one primary amine functional group of the plurality of primary amine functional groups of the branched polyethylenimine. The first reaction forms at least one group A represented by Formula I.

—N(H)-D-L Formula I

In Formula I, N is a nitrogen atom derived from a primary amine functional group of the plurality of primary amine functional groups of the branched polyethylenimine prior to the first reaction of the branched polyethylenimine with the first reagent, D is a moiety comprising a polar functional group, and L is a hydrophobic moiety, the hydrophobic moiety L comprising 16 or more carbon atoms.

The second reaction occurs between the first reagent and at least one secondary amine functional group of the plurality of secondary amine functional groups of the branched polyethylenimine. The second reaction forms at least one group B represented by Formula II.

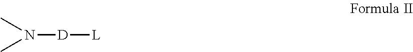

In Formula II, N is a nitrogen atom derived from a secondary amine functional group of the plurality of secondary amine functional groups of the branched polyethylenimine prior to the second reaction of the branched polyethylenimine with the first reagent, D is a moiety comprising a polar functional group, and L is a hydrophobic moiety, the hydrophobic moiety L comprising 16 or more carbon atoms.

The third reaction occurs between a second reagent and at least one tertiary amine functional group of the plurality of tertiary amine functional groups of the branched polyethylenimine. The third reaction converts the at least one tertiary amine functional group of the plurality of tertiary amine functional groups into an amine oxide functional group. The second reagent is an oxidizing agent.

The molecular weight of the branched polyethylenimine, from which the branched polyethylenimine derivative is formed, may be from 600 g/mol to 200,000 g/mole, from 2,000 g/mol to 150,000 g/mole, from 2,000 g/mole to 100,000 g/mole, from 5,000 g/mole to 50,000 g/mole, from 5,000 g/mole to 30,000 g/mole, or 8,000 g/mole to 20,000 g/mole.

The first charge control agent may be selected from the group consisting of a compound that is represented by Formula III, a compound that is represented by Formula IV, a compound that is represented by Formula V, a compound that is represented by Formula VI, a compound that is represented by Formula VII, a compound that is represented by Formula VIII, a compound that is represented by Formula IX, a compound that is represented by Formula X, a compound that is represented by Formula XI, a compound that is represented by Formula XII, a compound that is represented by Formula XIII, a compound that is represented by Formula XIV, a compound that is represented by Formula XV, and a compound that is represented by and Formula XVI.

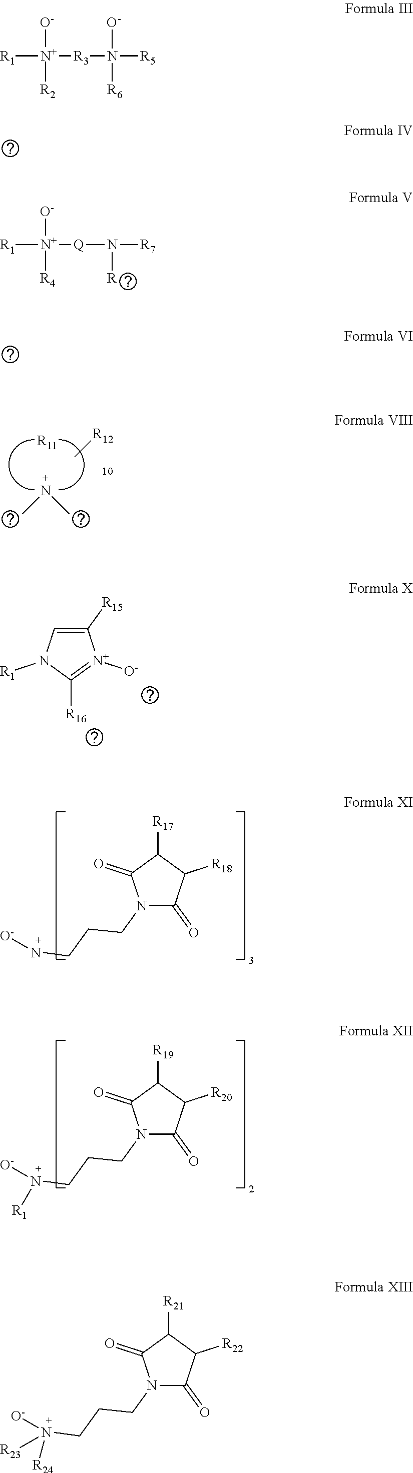

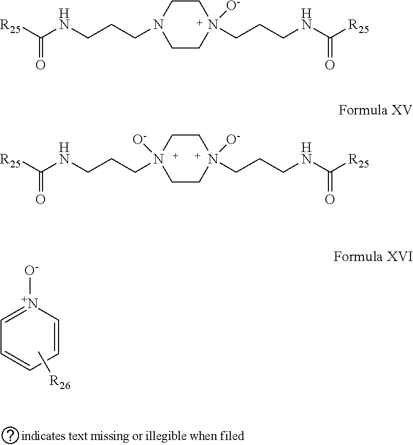

In the above Formulas (Formulas III to XVI),
(i) R₁ is R₂₇ or R₂₈, R₂₇ being represented by Formula XVII, R₂₈ being a hydrocarbon group having weight average molecular weight of 400 g/mol or larger,

-Q-X—R₂₉ Formula XVII,
wherein Q is a branched or nonbranched alkanediyl group comprising from 2 to 150 carbon atoms, X is a moiety comprising a polar functional group, and R₂₉ is a hydrophobic moiety, the hydrophobic moiety comprising 16 or more carbon atoms; X of Formula XVII may be selected from the group consisting of —O—C(O)—, —S—C(O)—, —C(O)—O—, —C(O)—S—, —N(H)—C(O)—, —N(R₃₀)—C(O)—, —C(O)—N(H)—, and —C(O)—N(R₃₀)—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.
(ii) R₂, R₃, R₄, R₅, R₆, R₇, R₈, R₉, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms;
(iii) R₁₂, R₁₃, R₁₄, R₁₅, R₁₆, R₁₇, R₁₈, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms;
(iv) at least one of R₂₃ and R₂₄ is R₁; at least one of R₁₃ and R₁₄ is a hydrophobic moiety; at least one of R₁₇ and R₁₈ is a hydrophobic moiety;
(v) o of Formulas VI and VII is 0 or 1;
(vi) R₁₁ of Formula VIII is a biradical moiety that forms a five- or six-membered ring, the five- or six-membered ring including a nitrogen atom of an amine oxide functional group, the five- or six-membered ring having a substituent R₁₂ that is covalently bonded to a carbon atom of the five- or six-membered ring;
(vii) R₂₅ and R₂₆ are hydrophobic moieties, each hydrophobic moiety comprising 16 or more carbon atoms.

The first charge control agent may be a branched polyethylenimine derivative as described above, where D of Formulas I and II are selected from the group consisting of —C(O)—, —C(O)—N(H)—, —C(O)—N(R₃₀)—, —C(O)—O—, and —C(O)—S—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

The first charge control agent may be a compound that is represented by Formula III, Formula IV, Formula V, Formula VI, Formula VII, Formula VIII, Formula IX, Formula X, Formula XII, Formula XIII, Formula XIV, Formula XV, or Formula XVI, and wherein R₁ is R₂₈, wherein R₂₈ is a hydrocarbon group that contains 30 to 1000 carbon atoms.

The first charge control agent may be a polyethylenimine derivative having at least one group J represented by Formula XVIII. The at least one group J may be formed by a fourth reaction between a secondary nitrogen atom of the plurality of the secondary amine functional groups of the branched polyethyleneimine and a nitrogen atom of the at least one group A represented by Formula I, wherein D of Formula I is —C(O)—,

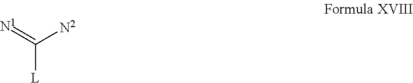

N¹ of Formula XVIII is a nitrogen atom derived from a primary amine functional group of the plurality of primary amine functional groups of the branched polyethylenimine as present prior to the first and fourth reactions. N² of Formula XVIII is a nitrogen atom derived from a secondary amine functional group of the plurality of secondary amine functional groups of the branched polyethylenimine as present prior to the fourth reaction. L of Formula XVIII is a hydrophobic moiety, the hydrophobic moiety L having 16 or more carbon atoms. Group J may be formed by nucleophilic attack of a secondary amine nitrogen atom on the carbon atom of the carbonyl functional group of Formula I, followed by dehydration.

The first charge control agent may be represented by Formula III, wherein R₃ of Formula III is represented by Formula XVII, wherein Q is a branched or nonbranched alkanediyl group comprising from 2 to 150 carbon atoms, X is a —O—C(O)— or —N(H)—C(O)—, and R₂₉ is a hydrophobic moiety, the hydrophobic moiety having 16 or more carbon atoms.

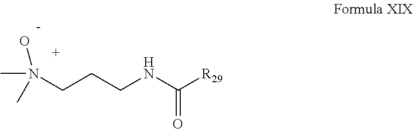

may be represented by Formula XIX or Formula the hydrophobic moiety having 16 or more carbon

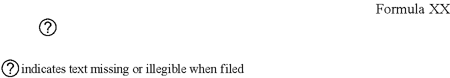

The inventive electrophoretic medium may comprise, in addition to the first charge control agent, a second charge control agent. The second charge control agent has at least one hydrophobic moiety and at least one amine functional group. The amine functional group may be selected from the group consisting of primary, secondary, tertiary, aromatic amine functional group, and combinations thereof.

The second charge control agent may be a branched polyethylenimine derivative, the branched polyethylenimine derivative having at least one hydrophobic moiety. The branched polyethylenimine derivative may be formed from a branched polyethylenimine by a first reaction and a second reaction. The branched polyethylenimine has a plurality of primary amine functional groups, a plurality of secondary functional groups, and a plurality of tertiary amine functional groups. Each primary amine functional group of the plurality of primary amine functional groups has a primary amine nitrogen atom. Each secondary amine functional group of the plurality of secondary amine functional groups has a secondary amine nitrogen atom. Each tertiary amine functional group of the plurality of tertiary amine functional groups has a tertiary amine nitrogen atom. The first reaction occurs between a first reagent and at least one primary amine functional group of the plurality of primary amine functional groups of the branched polyethylenimine, The first reaction forms at least one group A, the at least one group A represented by Formula I.

—N(H)-D-L Formula I

N of Formula I is a nitrogen atom derived from a primary amine functional group of the plurality of primary amine functional groups of the branched polyethylenimine as present prior to the first reaction of the branched polyethylenimine with the first reagent. D of Formula I is a moiety comprising a polar functional group. L of Formula I is a hydrophobic moiety, the hydrophobic moiety comprising 16 or more carbon atoms. The branched polyethylenimine derivative has a plurality of primary amine functional groups, a plurality of secondary amine functional groups, and a plurality of tertiary amine functional groups.

The second reaction occurs between the first reagent and at least one secondary amine functional group of the plurality of secondary amine functional groups of the branched polyethylenimine. The second reaction forms at least one group B represented by Formula II.

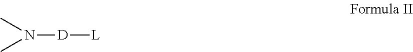

N of Formula II is a nitrogen atom derived from a secondary amine functional group of the plurality of secondary amine functional groups of the branched polyethylenimine prior to the second reaction of the branched polyethylenimine with the first reagent. D of Formula II is a moiety comprising a polar functional group. L of Formula II is a hydrophobic moiety, the hydrophobic moiety comprising 16 or more carbon atoms.

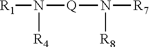

[symbol]

rol agent may be selected from the group consisting of a XXI, Formula XXII, Formula XXIII, Formula XXIV, XXVII, Formula XXVIII, Formula XXIX, Formula, and combinations thereof.

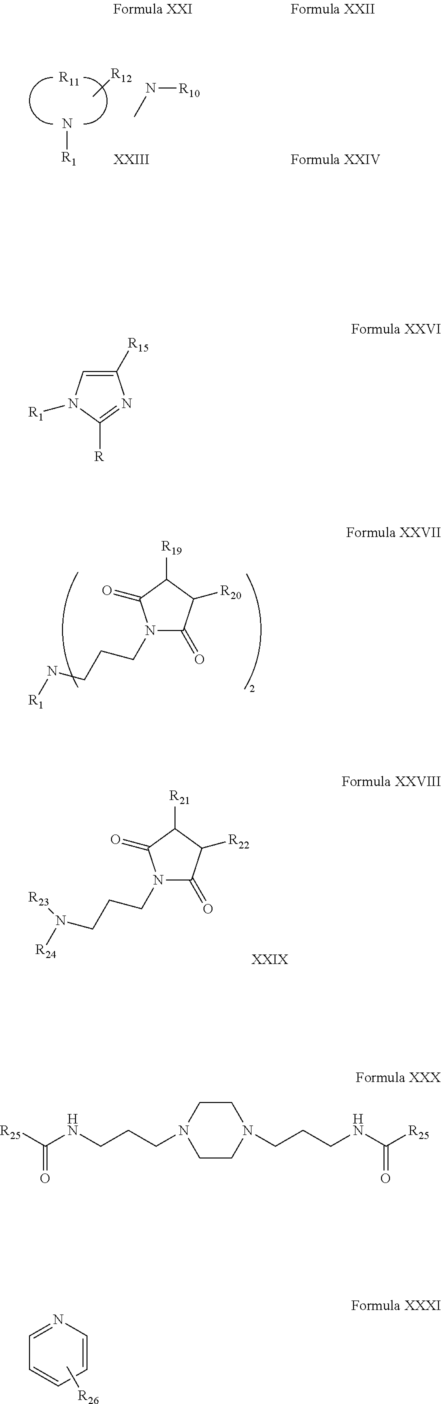

In the above Formulas (XXI to XXXI),
(i) R₁ is R₂₇ or R₂₈, R₂₇ being represented by Formula XVII, R₂₈ being a hydrocarbon group having weight average molecular weight of 400 g/mol or larger;

-Q-X—R₂₉ Formula XVII,
In Formula XVII, Q is a branched or nonbranched alkanediyl group comprising from 2 to 150 carbon atoms, X is a moiety comprising a polar functional group, and R₂₉ is a hydrophobic moiety, the hydrophobic moiety comprising 16 or more carbon atoms;
(ii) R₂, R₃, R₄, R₇, R₈, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms;
(iii) R₁₂, R₁₃, R₁₄, R₁₅, R₁₆, R₁₇, R₁₈, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms;
(iv) at least one of R₂₃ and R₂₄ is R₁; at least one of R₁₃ and R₁₄ is a hydrophobic moiety; at least one of R₁₇ and R₁₈ is a hydrophobic moiety;
(v) o of Formula XXIII is 0 or 1;
(vi) R₁₁ of Formula XXIV is a biradical moiety that forms a five- or six-membered ring, the five- or six-membered ring including a nitrogen atom of a tertiary amine functional group, the five- or six-membered ring having substituent R₁₂ that is covalently bonded to a carbon atom of the five- or six-membered ring.
(vii) R₂₅ and R₂₆ of Formulas XXX and XXXI respectively are hydrophobic moieties, each hydrophobic moiety comprising 16 or more carbon atoms.

The second charge control agent may be represented by Formula XXI, R₃ of Formula XXI being represented by Formula XVII, wherein Q is a branched or nonbranched alkanediyl group comprising from 2 to 150 carbon atoms, X is —O—C(O)— or —N(H)—C(O)—, and R₂₉ is a hydrophobic moiety, the hydrophobic moiety comprising 16 or more carbon atoms.

The second charge control agent is represented by Formula XXXII or Formula XXXIII; R₂₉ is a hydrophobic moiety, the hydrophobic moiety comprising 16 or more carbon atoms.

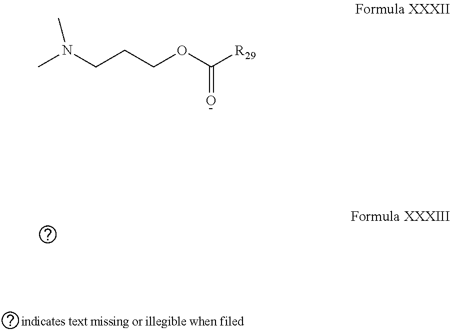

The inventive electrophoretic medium may comprise a first charge control agent, a second charge control agent, and a protic acid. The first charge control agent may be represented by Formula XX, wherein R₂₉ is a hydrophobic moiety, the hydrophobic moiety comprising 16 or more carbon atoms. R₂₉ of Formula XX may be selected from the group consisting of poly(hydroxystearic acid), poly(ricinoleic acid), and poly(isobutylene). The second charge control agent may be a branched polyethylenimine derivative as described above, wherein D of Formulas I and II is —C(O)—, and wherein L of Formulas I and II is selected from the group consisting of poly(hydroxystearic acid), poly(ricinoleic acid), and poly(isobutylene). The protic acid has pKa from 5 to −5.

The inventive electrophoretic medium may comprise a third and fourth types of electrically charged pigment particles. The first type of electrically charge pigment particles has a first color and a first charged polarity. The second type of electrically charge pigment particles has a second color and a second charged polarity. The third type of electrically charge pigment particles has a third color and second charged polarity. The fourth type of electrically charge pigment particles has a fourth color and a third charged polarity. The first color is white. The second color is non-white. The third color is non-white and different from the second color. The fourth color is non-white and different from the second and third colors. The second charge polarity is opposite to the first charge polarity. The third charge polarity may be the same as the first charge polarity or opposite to the first charge polarity.

In another aspect, the present invention provides an electro-optic display comprising a first electrode layer, an electro-optic material layer, and a second electrode layer. The first electrode layer is light transmissive. The second electrode layer comprises a plurality of pixel electrodes. The electro-optic material layer comprises a plurality of microcapsules or a plurality of microcells. Each microcapsule or microcell comprises the electrophoretic medium. The electro-optic material layer is disposed between the first electrode layer and the second electrode layer. The first electrode layer and the second electrode layer are configured to apply an electric field across the electro-optic material layer. The electrophoretic medium of the electro-optic display comprises a plurality of a first type of electrically charged pigment particles and a second type of electrically charged pigment particles, a first charge control agent, and a non-polar liquid. The first charge control agent has at least one amine oxide functional group and at least one hydrophobic moiety. The first type of electrically charge pigment particles has a first color and a first charged polarity. The second type of electrically charge pigment particles has a second color and a second charged polarity. The first color is different from the second color, and the first charge polarity is opposite to the second charge polarity. The plurality of the first and second type of electrically charged pigment particles are capable of moving through the non-polar liquid upon application of an electric field.

### BRIEF DESCRIPTION OF DRAWINGS

FIG. 1 provides a reaction scheme of a reaction between a primary amine of a branched polyethylenimine and a hydroxycarboxylic acid to form a product having an amide bond and a polymeric hydrophobic moiety.

FIG. 2 provides a reaction scheme of a reaction between a secondary amine of a branched polyethylenimine and a hydroxycarboxylic acid to form a product having an amide bond and a polymeric hydrophobic moiety.

FIG. 3 provides a reaction scheme of a reaction between an initially formed amide with a neighboring amine to form a product having a heterocyclic ring.

FIG. 4 provides the reaction of a branched polyethylenimine derivative with an oxidizing agent to convert tertiary amine functional groups to amine oxide functional groups.

FIG. 5 illustrates a side view of an electro-optic display comprising electrophoretic medium encapsulated in microcapsules. The electrophoretic display comprises, in order, a first electrode layer, an electro-optic material layer, a first adhesive layer, and a second electrode layer.

FIG. 6 illustrates a side view of an electro-optic display comprising electrophoretic medium encapsulated in microcapsules. The electrophoretic display comprises, in order, a first electrode layer, a second adhesive layer, an electro-optic material layer, a first adhesive layer, and a second electrode layer.

FIG. 7 illustrates a side view of an electro-optic display comprising electrophoretic medium encapsulated in microcells. The electrophoretic display comprises, in order, a first electrode layer, an electro-optic material layer including a sealing layer, a first adhesive layer, and a second electrode layer.

FIG. 8 provides voltage sweep color measurements during switching between optical states of an example of an inventive electro-optic display and an example of a comparative display showing improved switching speeds for the inventive display.

FIG. 9 illustrates an example of a waveform that may be used to switch the electro-optic displays to the corresponding optical states.

FIG. 10 illustrates graphs of color gamuts of inventive electro-optic and comparative electro-optic displays at two different temperatures (0 °C and 25 °C).

FIG. 11 are graphs of a* versus b* of (a) SNAP standard, (b) an inventive electro-optic display, and (c) a comparative electro-optic display at 0 °C. The graphs indicate differences in the total color gamut of the displays.

FIG. 12 are graphs of contrast ratios of an inventive electro-optic display and a comparative electro-optic display at two different temperatures (0 °C and 25 °C).

FIG. 13 shows color measurements during switching between optical states of two inventive electro-optic displays and a comparative electro-optic display; the displays comprise electrophoretic media having charge control agents that are polyethylenimine derivatives.

FIG. 14 shows color measurements during switching between optical states of two inventive electro-optic displays and a comparative electro-optic display; the displays comprise electrophoretic media containing a combination of charge control agents.

### DETAILED DESCRIPTION OF THE INVENTION

The present invention provides electrophoretic media comprising a first and second types of electrically charged pigment particles, a charge control agent, and a non-polar liquid. A particle that absorbs, scatters, or reflects light, either in a broad band or at selected wavelengths, is referred to herein as a pigment particle. The first charge control agent has at least one amine oxide functional group and at least one hydrophobic moiety. The electrophoretic media may be incorporated into electro-optic displays, front plane laminates, inverted front plane laminates, or double release sheets.

As used herein, the term “electrically charged pigment particles” are particles that have color and move in the electrophoretic medium of an electro-optic display upon application of an electric field across the electrophoretic medium, forming an image in the electro-optic display. A synonymous term to electrically charged pigment particles is “electrophoretic particles”.

As used herein, “head group” of a molecule, the molecule having both a hydrophilic and hydrophobic part, is the functional group of the hydrophilic part of the molecule. The molecule may have one head group or more than one head groups. The hydrophobic part of the molecule is also called “tail.”

The term “molecular weight” or “MW” as used herein refers to the weight average molecular weight, unless otherwise stated. The weight average molecular weight is measured by gel permeation chromatography.

The term “amine oxide” referring to a functional group, as used herein, means a functional group that contains a nitrogen atom that is bonded to an oxygen atom in an organic compound. The term “amine N-oxide” functional group is synonymous to the term “amine oxide functional group”. The amine oxide functional group can be represented by —N⁺—O⁻ or —N→O, the arrow representing a dative bond. In the case of the presence of an acid in the electrophoretic medium, the resulting functional group is still an amine oxide even though it may be protonated, which may be represented by —N⁺—O⁻. Examples of compounds that have an amine oxide functional group are provided below (Formulas XXXIV and XXXV), each of which is represented by a pair of resonance structures. These compounds may be formed by oxidation of aliphatic amines or heteroaromatic amines, such as a pyridine. Group R may be an alkyl group. Group R in the pyridine ring may be bonded to any of the four carbon atoms of the aromatic ring. Amine oxides may be also formed by oxidation of primary and secondary amines.

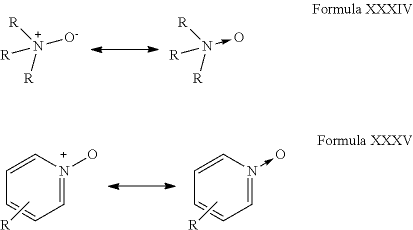

As used herein, the term pKa of a material is the negative logarithm of the acid dissociation constant (Ka) of the material in an aqueous solution at 25 °C. The smaller the value of pKa, the stronger the acid. The values of pKa of acids can be found in the literature as measured or predicted. Negative pKa means that the corresponding acid is very strong. It is well established in chemistry that a conjugate base of a strong acid is a weak base.

The term “carboxylic acid derivative” refers to a molecule that can be produced from a carboxylic acid by replacing the hydroxide (OH) group with other functional groups. The carboxylic acid derivative can take place in condensation reactions with alcohols or amines to prepare esters or amides. Examples of carboxylic acid derivatives include acyl halides and acid anhydrides. Acyl halides and acid anhydrides are more reactive than carboxylic acids towards alcohols and amines.

As used herein, the term “hydrophobic moiety” is a group of atoms, the group of atoms being non-polar in nature. Hydrophobic moieties may contain an aliphatic hydrocarbon chain, an aromatic ring, a heterocyclic ring. The hydrophilic moiety has 16 carbon atoms or more. A “polymeric hydrophobic moiety” is a hydrophobic moiety that has a weight average molecular weight of 600 g/mol or larger.

As used herein, the terms “comprising”, “including”, “containing”, and “having” are intended to be inclusive, in an open-ended sense, and do not exclude additional, unrecited elements or method steps.

As used herein, a compound “having”, “comprising”, “including”, or “containing” a specified functional group refers to a compound in which the specified functional group is present in the molecular structure of the compound. In this application, examples of compounds include a branched polyethylenimine, a branched polyethylenimine derivative, a charge control agent, and a compound that is represented by a Formula.

The term positive voltage, referring to the voltage applied between the first light transmissive electrode and a pixel electrode of the second electrode layer, is a voltage that causes movement of electrophoretic particles that have positive charge polarity towards the first light transmissive electrode. That is, when it is stated that a voltage of a positive value is applied between the first light transmissive electrode and a pixel electrode of the second electrode layer, positively charged particles move towards the first light transmissive electrode. Analogously, the term negative voltage, referring to the voltage applied between the first light transmissive electrode and a pixel electrode of the second electrode layer, is a voltage that causes movement of electrophoretic particles that have negative charge polarity to move towards the first light transmissive electrode. That is, when it is stated that a voltage of a negative value is applied between the first light transmissive electrode and a pixel electrode of the second electrode layer, negatively charged particles move towards the first light transmissive electrode

Charge control agents (CCA) are included in electrophoretic media of electro-optic displays to control the charge of the electrophoretic particles. Typically, the CCAis a compound that contains a polar group (head group) and a non-polar group (tail), or more than one polar group and more than one non-polar groups. A CCA compound may be complexed or adsorbed on the surface of the electrophoretic particles. It is thought that charge control agents form reverse micelles in the electrophoretic medium, wherein reverse micelles comprise a polar core surrounded by the non-polar tails of CCA compounds in the non-polar liquid of the electrophoretic medium. Pigment particles may be in the reverse micelle core. Generally, the mechanism in which CCA affects the charge of electrophoretic particles is not fully understood. It is also likely that CCAs contribute to the stabilization of electrophoretic particles, reducing particle aggregation.

The electrophoretic media according to the various embodiments of the present invention comprises a plurality of a first and second type of electrically charged pigment particles, a charge control agent, and a non-polar liquid.

The weight content of the first charge control agent, or the weight content of the first and second charge control agents, in the electrophoretic medium may be from 0.1 weight percent to 8.0 weight percent by weight of the electrophoretic medium. The weight content of the first charge control agent, or the weight content of a combination of the first and second charge control agents, in the electrophoretic medium may be from 0.1 weight percent to 7.0 weight percent, from 0.1 weight percent to 6.0 weight percent, from 0.1 weight percent to 5.0 weight percent, from 0.1 weight percent to 4.0 weight percent, from 0.1 weight percent to 3.0 weight percent, from 0.1 weight percent to 2.0 weight percent, from 0.2 weight percent to 8.0 weight percent, from 0.2 weight percent to 5.0 weight percent, from 0.2 weight percent to 3.0 weight percent, from 0.3 weight percent to 6.0 weight percent, from 0.3 weight percent to 4.0 weight percent, from 0.3 weight percent to 2.0 weight percent, from 0.4 weight percent to 5.0 weight percent, from 0.4 weight percent to 3.0 weight percent, or from 0.5 weight percent to 5.0 weight by weight of the electrophoretic medium.

The first charge control agent, or the combination of the first and second charge control agents, may be present in the electrophoretic medium at a concentration of greater than 0.5 g of the first charge control agent, or the first and second charge control agents, for every 100 g of electrophoretic particles. The first charge control agent, or the combination of the first and second charge control agents, may be present in the electrophoretic medium at a concentration of greater than 1.0 g, 1.5 g, 2.0 g, or 3.0 g of charge control agent for every 100 g of electrophoretic particles For example, the first charge control agent, or the combination of the first and second charge control agents, to electrophoretic particles weight ratio may be 1:30, 1:25, 1:20, or 1:10. The first charge control agent may be present in the electrophoretic medium in a concentration of from 0.1 weight percent to 10 weight percent, from 0.4 weight percent to 8.0 weight percent, from 0.6 weight percent to 6.0 weight percent, from 0.8 weight percent to 4.0 weight percent, or from 1.0 weight percent to 3.0 weight percent by weight of the electrophoretic medium. In the case where the electrophoretic medium contains a first and a second charge control agent, the weight ratio of the first charge control agent to the second charge control agent may be from 0.2:1.0, from 0.5:1.0, from 0.7:1.0, from 1.0:1.0, from 1.0:1.5. from 1.0:2.0 from 1.0:3.0 from 1.0:4.0 or from 1.0:5.0.

The electrophoretic medium of the present invention may contain electrophoretic particles in a content of 15 to 65 weight percent by weight of the electrophoretic medium. The electrophoretic medium of the present invention may contain electrophoretic particles in a content of 20 to 60 weight percent, from 25 to 55 weight percent, or from 30 to 50 weight percent by weight of the electrophoretic medium. The electrophoretic medium may contain two, three, four, or five types of electrophoretic particles. The color of the different types of the electrophoretic particles may be selected from a group consisting of white, cyan, magenta, yellow, green, red, blue, black, and orange. In one example the electrophoretic medium contains four types of electrophoretic particles. The four types of electrophoretic particles may have white, cyan, magenta, and yellow color, respectively. The color of the four types of electrophoretic particles may be selected from a group consisting of white, cyan, magenta, yellow, green, red, and blue.

The electrophoretic medium contains a non-polar liquid in a content of 30 to 75 weight percent by weight of the electrophoretic medium. The electrophoretic medium may contain a non-polar liquid in a content of 30 to 70 weight percent, from 35 to 65 weight percent, from 40 to 60 weight percent, or from 45 to 60 weight percent by weight of the electrophoretic medium. The non-polar liquid of the electrophoretic medium may comprise an aliphatic hydrocarbon, a cycloaliphatic hydrocarbon, an aromatic hydrocarbon, a halogenated aliphatic hydrocarbon, a polydimethylsiloxane, or mixture thereof.

The electrophoretic medium may also comprise a protic acid. The protic acid of the electrophoretic medium may have pKa lower than 5.0, lower than 4.5, lower than 4.0, lower than 3.5, lower than 3.0, lower than 2.5, lower than 2.0, or lower than 1.0. The pKa of the protic acid may be from 5.0 to −16, from 5.0 to −5.0, from 5.0 to −3.0, from 5.0 to −2.0, from 5.0 to −1.0, from 5.0 to 0.0. from 4.8 to −12, from 4.6 to −10, from 4.5 to −6, from 4.4 to −4.0, from 4.2 to −3.0, from 4.1 to −1.0, or from 4.0 to 0. Protic acids may be inorganic acids or organic acids. Nonlimiting examples of protic acids include sulfuric acid, sulfonic acids, phosphoric acid, phosphoric acid derivatives, carboxylic acids, and hydrochloric acid. Examples of protic acids include bis(2-ethylhexyl)phosphate, trifluoromethanesulfonic acid, lactic acid, acetic acid, formic acid, and citric acid. The content of the protic acid in the electrophoretic medium may be from 0.05 to 1 weight percent by weight of the electrophoretic medium. The content of the protic acid in the electrophoretic medium may be from 0.05 to 3.0 weight percent, from 0.1 to 2.0 weight percent, from 0.2 to 1.0 weight percent, or from 0.3 to 0.8 weight percent by weight of the electrophoretic medium.

The first charge control agent of the electrophoretic medium of the present invention is a compound having at least one amine oxide functional group and at least one hydrophobic moiety.

The first charge control agent and the second charge control agent may have a weight average molecular weight that is greater than or equal to 400 g/mol, greater than or equal to 600 g/mol, greater than or equal to 800 g/mol, or greater than or equal to 1,000. The first charge control agent may have a weight average molecular weight that is from 400 g/mol to 200,000 g/mol, from 500 g/mol to 150,000 g/mol, from 600 g/mol to 100,000 g/mol, from 700 g/mol to 50,000 g/mol, from 800 g/mol to 35,000 g/mol, from 900 g/mol to 30,000 g/mol, from 1,000 g/mol to 25,000, or from 1,500 g/mol to 20,000 g/mol.

The first charge control agent may be a branched polyethylenimine derivative. The branched polyethylenimine derivative has at least one hydrophobic moiety. The branched polyethylenimine derivative may be formed from a branched polyethylenimine. The branched polyethylenimine has a plurality of primary amine functional groups, a plurality of secondary functional groups, and a plurality of tertiary amine functional groups.

The formation of the branched polyethylenimine derivative may involve a first reaction, a second reaction, and a third reaction. The first reaction occurs between a first reagent and at least one primary amine functional group of the plurality of primary amine functional groups of the branched polyethylenimine. the first reaction forming at least one group A represented by Formula I,

—N(H)-D-L Formula I

wherein N is a nitrogen atom derived from a primary amine functional group of the plurality of primary amine functional groups of the branched polyethylenimine prior to the first reaction of the branched polyethylenimine with the first reagent, D is a moiety comprising a polar functional group, and L is a hydrophobic moiety, the hydrophobic moiety L comprising 16 or more carbon atoms.

The second reaction occurs between the first reagent and at least one secondary amine functional group of the plurality of secondary amine functional groups of the branched polyethylenimine, the second reaction forming at least one group B represented by Formula II,

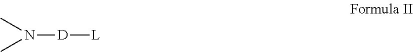

wherein N is a nitrogen atom derived from a secondary amine functional group of the plurality of secondary amine functional groups of the branched polyethylenimine prior to the second reaction of the branched polyethylenimine with the first reagent, D is a moiety comprising a polar functional group, and L is a hydrophobic moiety, the hydrophobic moiety L comprising 16 or more carbon atoms.

The third reaction occurs between a second reagent and at least one tertiary amine functional group of the plurality of tertiary amine functional groups of the branched polyethylenimine. The third reaction converts the at least one tertiary amine functional group of the plurality of tertiary amine functional groups into an amine oxide functional group, the second reagent being an oxidizing agent.

D of Formulas I and II may be selected from the group consisting of —C(O)—, —C(O)—N(H)—, —C(O)—N(R₃₀)—, —C(O)—O—, and —C(O)—S—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

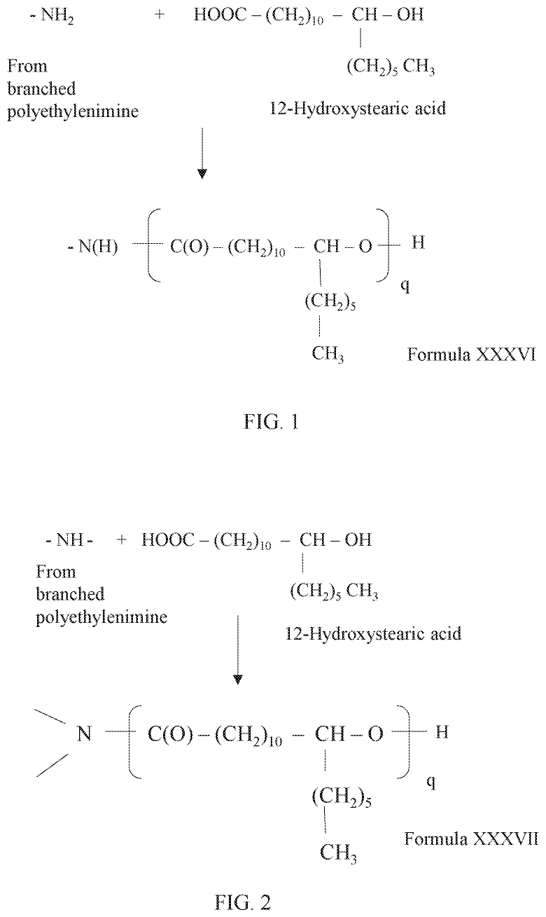

An example of a scheme of a condensation reaction between a primary amine of a branched polyethylenimine and a reagent is illustrated in FIG. 1. The reagent is this example is 12-hydroxystearic acid, and the product of the reaction has an amide bond and a polymeric hydrophobic moiety (Formula XXXVI). In Formula XXXVI, q represents the number of the repeating units in the polymeric hydrophobic group. An example of scheme of the condensation reaction of a secondary amine of a branched polyethylenimine and a reagent is illustrated in FIG. 2. The reagent is this example is also 12-hydroxystearic acid, and the product of the reaction has an amide bond and a polymeric hydrophobic moiety (Formula XXXVII). In Formula XXXVII, q represents the number of the repeating units in the polymeric hydrophobic group.

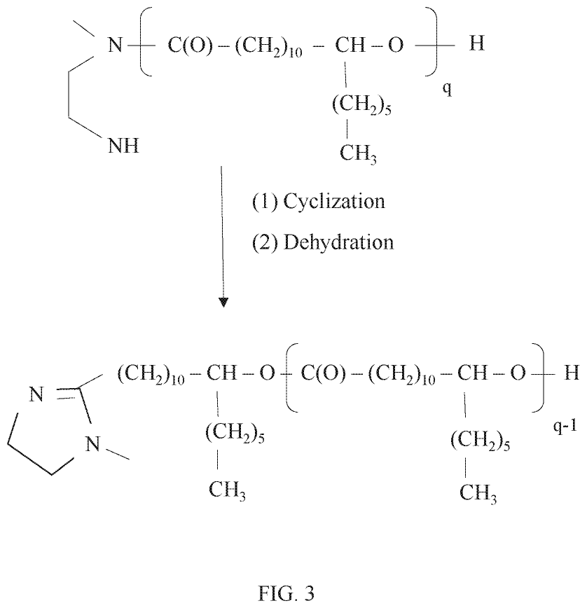

It is possible that the initial formed amide functional group, which is formed from the reaction of a primary amine functional group of the branched polyethylenimine with the reagent, reacts with a neighboring secondary amine functional group of the polyethylenimine to form a five-member ring dihydroimidazole. It is also possible that the initial formed amide functional group, which is formed from the reaction of a secondary amine functional group of the branched polyethylenimine with the reagent, reacts with a neighboring primary amine functional group of the polyethylenimine to form a five member ring dihydroimidazole, according to the reaction scheme that is provided in FIG. 3. In the product of the reaction scheme of FIG. 3, q−1 represents the number of the repeating units in the polymeric hydrophobic group.

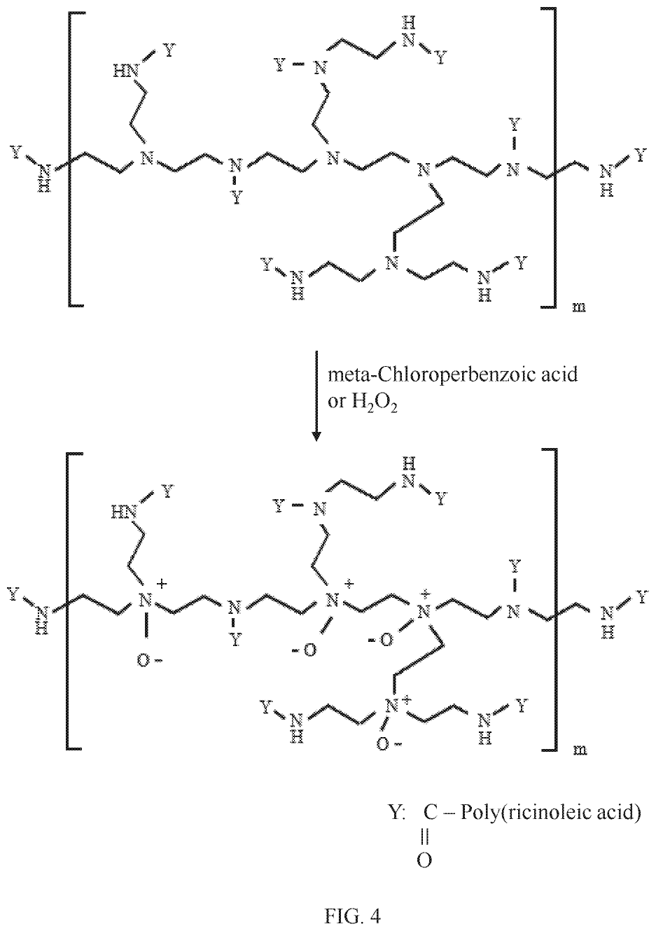

The amine oxide functional group of the first charge control agent is formed by the oxidation of a tertiary amine with an oxidizing agent, such as hydrogen peroxide or meta-chloroperbenzoic acid. An example of this reaction is provided in FIG. 4.

The first charge control agents may be represented by Formulas III to XIV, XIX, and XX, as described above. The first charge control agent may be formed by condensation reactions between a reactant that contains one or more amines and a reagent that contains a carboxylic acid or a carboxylic acid derivative. The molecular structure of the reagent may contain one or more carboxylic acid groups or one or more carboxylic acid derivatives. For example, the molecular structure of the reagent may contain two carboxylic acid groups or two carboxylic acid derivatives. In this case, the product of the reaction may contain a polymeric hydrophobic moiety that forms bonds with two nitrogen atoms of the same reactant molecule that contains two amine functional groups. The product of the reaction may also contain a polymeric hydrophobic moiety that forms bonds with two different reactant molecules, each reactant molecule containing at least one amine functional group.

The second charge control agent has at least one hydrophobic moiety and at least one amine functional group. The amine functional group is selected from the group consisting of primary, secondary, tertiary, aromatic amine functional group, and combinations thereof.

The second charge control agent may be a branched polyethylenimine derivative, the branched polyethylenimine derivative having at least one hydrophobic moiety. The branched polyethylenimine derivative is formed from a branched polyethylenimine by a first reaction and a second reaction. The branched polyethylenimine has a plurality of primary amine functional groups, a plurality of secondary functional groups, and a plurality of tertiary amine functional groups. The first reaction occurs between a first reagent and at least one primary amine functional group of the branched polyethylenimine, the first reaction forming at least one group A, the at least one group A represented by Formula I. The second reaction occurs between the first reagent and at least one secondary amine functional group of the branched polyethylenimine, the second reaction forming at least one group B represented by Formula II.

The second charge control agent may be selected from the group consisting of compounds represented by Formula XXI, Formula XXII, Formula XXIII, Formula XXIV, Formula XXV, Formula XXVI, Formula XXVII, Formula XXVIII, Formula XXIX, Formula XXX, Formula XXXI, and combinations thereof, as described above.

The second charge control agent may be represented by Formula XXXII or Formula XXXIII, wherein R₂₉ is a hydrophobic moiety, the hydrophobic moiety comprising 16 or more carbon atoms. Group R₂₉ may be selected from the group consisting of poly(hydroxystearic acid), poly(ricinoleic acid), and poly(isobutylene).

The electrophoretic medium of a first embodiment of the present invention comprises a first charge control agent that has at least one amine oxide functional group and at least one hydrophobic moiety. The electrophoretic medium of the first embodiment may also comprise a protic acid.

The electrophoretic medium of a second embodiment of the present invention comprises a first and a second charge control agents. The first charge control agent has at least one amine oxide functional group and at least one hydrophobic moiety. The second charge control agent has at least one hydrophobic moiety and at least one amine functional group, wherein the amine functional group is selected from the group consisting of primary, secondary, tertiary, aromatic amine functional group, and combinations thereof. The electrophoretic medium of the second embodiment may also comprise a protic acid.

An example of an electrophoretic medium of the second embodiment comprises (i) a non-polar liquid, (ii) a plurality of first type of electrically charged particles, (iii) a plurality of second type of electrically charged particles, (iv) a second charge control agent that is a branched polyethylenimine derivative, the branched polyethylenimine derivative having at least a hydrophobic moiety, a plurality of primary amine functional groups, a plurality of secondary amine functional groups, and a plurality of tertiary amine functional groups, and (v) a first charge control agent. The first charge control agent is selected from the group consisting of a the branched polyethylenimine derivative, a compound that is represented by Formula III, a compound that is represented by Formula IV, a compound that is represented by Formula V, a compound that is represented by Formula VI, a compound that is represented by Formula VII, a compound that is represented by Formula VIII, a compound that is represented by Formula IX, a compound that is represented by Formula X, a compound that is represented by Formula XI, a compound that is represented by Formula XII, a compound that is represented by Formula XIII, a compound that is represented by Formula XIV, a compound that is represented by Formula XV, a compound that is represented by and Formula XVI, and mixture thereof. When the first charge control agent is a branched polyethylenimine derivative, the branched polyethylenimine derivative has at least one hydrophobic moiety and at least one amine oxide functional group. The definitions of the variable groups of the variable Formulas are provided above. This example of electrophoretic medium may also comprise a protic acid.

Another example of an electrophoretic medium of the second embodiment comprises (i) a non-polar liquid, (ii) a plurality of first type of electrically charged particles, (iii) a plurality of second type of electrically charged particles, (iv) a first charge control agent, and (v) a second charge control agent. The second charge control agent is a compound that is represented by Formula XXXII of Formula XXXIII, wherein R₂₉ is a hydrophobic moiety, the hydrophobic moiety comprising 16 or more carbon atoms. The first charge control agent is selected from the group consisting of a the branched polyethylenimine derivative, a compound that is represented by Formula III, a compound that is represented by Formula IV, a compound that is represented by Formula V, a compound that is represented by Formula VI, a compound that is represented by Formula VII, a compound that is represented by Formula VIII, a compound that is represented by Formula IX, a compound that is represented by Formula X, a compound that is represented by Formula XI, a compound that is represented by Formula XII, a compound that is represented by Formula XIII, a compound that is represented by Formula XIV, a compound that is represented by Formula XV, a compound that is represented by and Formula XVI, and mixture thereof. When the first charge control agent is a branched polyethylenimine derivative, the branched polyethylenimine derivative has at least one hydrophobic moiety and at least one amine oxide functional group. The definitions of the variable groups of the variable Formulas are provided above. This example of electrophoretic medium may also comprise a protic acid.

A typical electro-optic display may have an electro-optic material layer that comprises an electrophoretic medium, which is encapsulated in microcapsules or microcells, as described in U.S. Pat. No. 6,982,178. FIG. 5 shows a side view of an example of a portion of an electro-optic display having microcapsules. Electro-optic display 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having electrically charged pigment particles and a charge control agent in a non-polar liquid. Electrophoretic medium 122 comprises a plurality of first type of electrically charged pigment particles and a plurality of second type of electrically charged pigment particles. Electrophoretic medium may further comprise a plurality of third type of electrically charged pigment particles. Electrophoretic medium 122 may further comprise a plurality of fourth type of electrically charged pigment particles. Electrophoretic medium 122 may further comprise a plurality of fifth type of electrically charged pigment particles. Typically, the plurality of microcapsules are retained within a polymeric binder 132. A viewer can view the image of display 100 from the viewing side 150. At least one type of electrically charged pigment particles may comprise an organic pigment. The electro-optic material layer 100 may be constructed from a front plane laminate, as described in the background of the invention.

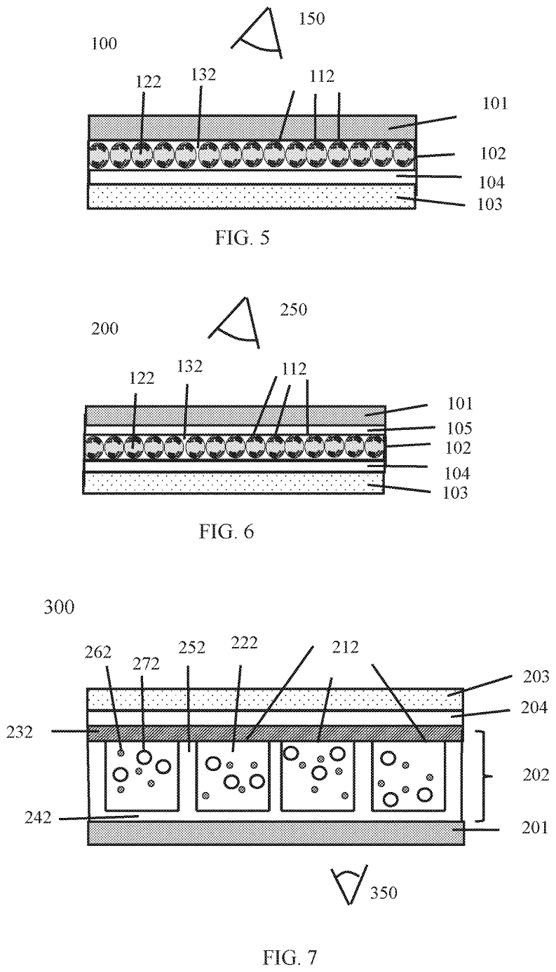

Another example of an electro-optic display is shown in FIG. 6. FIG. 6 illustrates a side view of an example of the basic structure of a portion of an electro-optic display having microcapsules. Electro-optic display 200 has a viewing side 150. It comprises, in order, a first electrode layer 101 comprising a light transmissive electrode, a second adhesive layer 105, an electro-optic material layer 102, a first adhesive layer 104, and a second electrode layer 103, comprising a plurality of pixel electrodes. The second adhesive layer 105 connects first electrode layer 101 with electro-optic material layer 102. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having electrically charged pigment particles and a charge control agent in a non-polar liquid. Electrophoretic medium 122 comprises a plurality of first type of electrically charged pigment particles and a plurality of second type of electrically charged pigment particles. Electrophoretic medium may further comprise a plurality of third type of electrically charged pigment particles. Electrophoretic medium 122 may further comprise a plurality of fourth type of electrically charged pigment particles. Electrophoretic medium 122 may further comprise a plurality of fifth type of electrically charged pigment particles. At least one type of electrically charged pigment particles may comprise an organic pigment. Typically, the plurality of microcapsules are retained within a polymeric binder 132. A viewer can view the image of display 200 from the viewing side 250. The electro-optic material layer 100 may be constructed from a front plane laminate, as described in the background of the invention.

The microcapsule electro-optic displays of FIGS. 5 and 6 may further comprise a light transmissive front substrate (not shown in FIGS. 5 and 6), which is adjacent to the first electrode layer 101, wherein the electrode layer is disposed between the front substrate and the electro-optic material layer (for the display of FIG. 5) or between the front substrate and the second adhesive layer (for the display of FIG. 5). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

An example of an electro-optic display that comprises microcells is illustrated in FIG. 6. Electro-optic display 300 of FIG. 7 comprises, in order, a first electrode layer 201, an electro-optic material layer 202, an adhesive layer 204, and a second electrode layer 203, which comprises a plurality of pixel electrodes. Adhesive layer 204 connects sealing layer 232 of the electro-optic material layer 202 with second electrode layer 203 Electro-optic material layer 202 of electro-optic display 300 comprises a plurality of microcells 212 and a sealing layer 232. Each microcell 212 of the plurality of microcells has a bottom 242, partition walls 252, and an opening, the sealing layer 232 spanning the opening of each microcell. Each microcell 212 of the plurality of microcells comprises electrophoretic medium 222. Electrophoretic medium 222 comprises a plurality of first type of electrically charged pigment particles 272, a plurality of second type of electrically charged pigment particles 262 and a charge control agent in a non-polar liquid. Electrophoretic medium 222 may further comprise a plurality of third type of electrically charged pigment particles. Electrophoretic medium 222 may further comprise a plurality of fourth type of electrically charged pigment particles. Electrophoretic medium 222 may further comprise a plurality of fifth type of electrically charged pigment particles. electrically A viewer can view the image of display 300 from the viewing side 350. The electro-optic material layer 300 may be constructed from a front plane laminate, as described in the background of the invention. The microcell electro-optic displays of FIG. 7 may further comprise a light transmissive front substrate (not shown in FIG. 7), which is adjacent to the first electrode layer 201, wherein the electrode layer is disposed between the front substrate and the electro-optic material layer. The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

In the electro-optic displays of FIGS. 5, 6, and 7, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic displays. Microcell arrays suitable for use with the invention can be created with microembossing.

### EXAMPLES

### Example 1: Preparation of Charge Control Agent CCA-671 (Second Charge Control Agent)

A 2-liter, 4-necked flask was fitted with a mechanical mixer, thermocouple, addition port, and a Dean-Stark type condensing system. Ricinoleic acid (1200.6 g, Girnar Industries) was added followed by branched polyethylenimine (70.37 g, number average molecular weight of 10,000 g/mol supplied by Sigma) with mixing. The system was then purged under a nitrogen atmosphere for the remainder of the reaction. Toluene (110 g) was added, and the mixture was heated to reflux to remove water that was formed from the polymerization. After 4 hours the reaction was cooled to ambient temperature and maintained under nitrogen overnight. After this period, zirconium (IV) butoxide (5.33 g, 80% in n-butanol, supplied by Sigma) was added and the reaction brought to reflux. Toluene was removed, as needed, to bring the reaction temperature to 195-200 °C. Reflux continued at 195-200 °C until the final acid value was achieved. At the completion of the reaction, the volatiles were removed under reduced pressure, and the product was diluted with Isopar E to the desired final solids of 55.2%. The measured Acid Values was 1.5 and the Total Base Number was 21.4.

### Example 2: Preparation of Charge Control Agent CCA-695 (First Charge Control Agent)

The solution of charge control agent CCA-671 in Isopar E from Example 1 (2.255 g, 1539-54 at 55.2 weight % solids) was mixed with meta-chloroperbenzoic acid (0.0615 g) in scintillation vial. The material was further diluted to 30.0 weight % with additional Isopar E.

### Example 3: Preparation of Charge Control Agent CCA-696 (First Charge Control Agent)

The solution of charge control agent CCA-671 in Isopar E from Example 1 (3.0485 g, at 55.2 weight % solids) was mixed with a 30 weight % aqueous solution of H₂O₂ (0.154 g) in a scintillation vial. The contents were bath sonicated followed by evaporation to remove water. Isopar E was added to 30.0% solids yielding a clear, light-yellow mixture.

### Example 4: Preparation of Charge Control Agent CCA-700 (First Charge Control Agent)

The solution of charge control agent CCA-671 in Isopar E from Example 1 (17.64 g, at 55.2 weight % solids) was mixed with a 30 weight % aqueous solution of H₂O₂ (0.203 g) in a scintillation vial. The contents were bath sonicated followed by evaporation to remove water. Isopar E was added to 30.0 weight % solids yielding a clear, light-yellow solution.

### Example 5: Preparation of Charge Control Agent CCA-702 (First Charge Control Agent)

The solution of charge control agent CCA-671 in Isopar E from Example 1 (23.26 g, at 55.2 weight % solids) was mixed with 30% H₂O₂ aqueous solution (3.20 g g) in a round bottom flask fitted with a reflux condenser. The contents were heated at 60 °C overnight followed by evaporation to remove water and other volatiles. Isopar E was added to make a clear, light-yellow solution of 30.0 weight % solids.

### Example 6: Preparation of Charge Control Agent CCA-703 (First Charge Control Agent)

An amount of 15.18 g of polymer (3.004 milliequivalents tertiary amine), which is formed from the reaction of 3-(dimethylamino)-1-propylamine with ricinoleic acid as disclosed in Example 1 of U.S. Pat. No. 12,195,586 B2 (represented by Formula XIX of U.S. Pat. No. 12,195,586 B2), was dissolved in a blend of toluene (7.90 g) and isopropyl alcohol (7.40 g). Into this solution was added 30 weight % aqueous solution of hydrogen peroxide (0.828 g). After a few minutes, the hazy mixture clarified. Subsequently, the solution was kept overnight at 60 °C. After this period, the solution was diluted with additional toluene and water, the layers were separated and the organic phase was concentrated by removing the volatile materials, resulting in a light-yellow oil (12.44 g). Charge control agent CCA-703 is represented by Formula XX, where R₂₉ is poly(ricinoleic acid).

### Example 7: Preparation of Charge Control Agent CCA-705 (First Charge Control Agent)

Into a solution of CCA 703 from Example 6 (1.118 g at 60.0 weight % solids) was added 0.0842 g of bis(2-ethylhexyl)phosphate. The weight ratio of CCA-703:bis(2-ethylhexyl)phosphate is 7.97:1, which corresponds to excess acid.

### Comparative Example 8: Preparation of Charge Control Agent CCA-111

The preparation of charge control agent CCA-111 was described in Example 1 of U.S. Pat. No. 12,195,586 B2 and is represented by Formula XXXVIII.

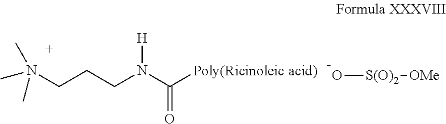

### Example 9: Preparation of Electro-Optic Displays

An electrophoretic medium was prepared by mixing dispersions of white, cyan, magenta, and yellow pigment particles in Isopar E, and a charge control agent. The electrophoretic medium comprises (a) 55 weight percent of Isopar E, (b) 44 weight percent of electrophoretic particles, (c) 1 weight percent of the sum of charge control agents and the protic acid. The weight ratio of White:Cyan:Magenta:Yellow electrophoretic particles was 9.7:1.2:1.0:1.0, respectively. The electrophoretic medium was used to prepare an electro-optic display. The following Examples 9A to 9G involved electro-optic displays comprising electrophoretic media according to Example 9. Each Example 9A to 9G comprises a different combination of charge control agents.

Comparative Example 9A: The electrophoretic medium according to Example 9 containing charge control agent CCA-671 from Comparative Ex. 1. The weight content of the charge control agent was 1.0 percent by weight of the electrophoretic medium.

Example 9B: The electrophoretic medium according to Example 9 containing a combination of charge control agent CCA-696 from Ex. 3 and charge control agent CCA-671 from Ex. 1 in weight ratio CCA-696:CCA-671 of 1:1. The total weight content of the charge control agents was 1.0 percent by weight of the electrophoretic medium.

Example 9C: The electrophoretic medium according to Example 9 containing a combination of charge control agent CCA-700 from Ex. 4 and charge control agent CCA-671 from Ex. 1 in weight ratio CCA-700:CCA-671 of 1:1. The total weight content of the charge control agents was 1.0 percent by weight of the electrophoretic medium.

Example 9D: The electrophoretic medium according to Example 9 containing a combination of charge control agent CCA-703 from Ex. 6. The total weight content of the charge control agent was 1.0 percent by weight of the electrophoretic medium.

Example 9E: The electrophoretic medium according to Example 9 containing a combination of charge control agent CCA-705 from Ex. 7 and charge control agent CCA-671 from Ex. 1 in weight ratio CCA-705:CCA-671 of 1:1. The total weight content of the charge control agents was 1.0 percent by weight of the electrophoretic medium.

Comparative Example 9F: The electrophoretic medium according to Example 9 containing charge control agent CCA-111 from Comparative Ex. 8. The weight content of the charge control agent was 1.0 percent by weight of the electrophoretic medium.

Example 9G: The electrophoretic medium according to Example 9 containing a combination of charge control agent CCA-695 from Ex. 2 and charge control agent CCA-671 from Ex. 1 in weight ratio CCA-695:CCA-671 of 1:1. The total weight content of the charge control agents was 1.0 percent by weight of the electrophoretic medium.

Comparative Example 9H: The electrophoretic medium according to Example 9 containing a combination of charge control agent CCA-671 (from Ex. 1) and charge control agent CCA-111 (from Ex. 8) in weight ratio CCA-671:CCA-111 of 1:1. The total weight content of the charge control agents was 1.0 percent by weight of the electrophoretic medium.

Example 91: The electrophoretic medium according to Example 9 containing a combination of charge control agent CCA-703 from Ex. 6 and charge control agent CCA-671 from Ex. 1 in weight ratio of CCA-703:CCA-671 of 1:1. The total weight content of the charge control agents was 1.0 percent by weight of the electrophoretic medium.

Example 9J: The electrophoretic medium according to Example 9 containing a combination of charge control agent CCA-705 from Ex. 7 and charge control agent CCA-671 from Ex. 1. That is, the electrophoretic medium contains a protic acid material bis(2-ethylhexyl)phosphate, because CCA-705 is a combination of CCA-703 and bis(2-ethylhexyl)phosphate. The weight ratio of CCA-671:CCA-703: bis(2-ethylhexyl)phosphate is 1:1:0.12. The total weight content of CCA-703, CCA-671, and bis(2-ethylhexyl)phosphate was 1.0 weight percent by weight of the electrophoretic medium.

### Example 10: Switching Speed Measurement (Ex. 9D Versus Comparative Ex. 9F)

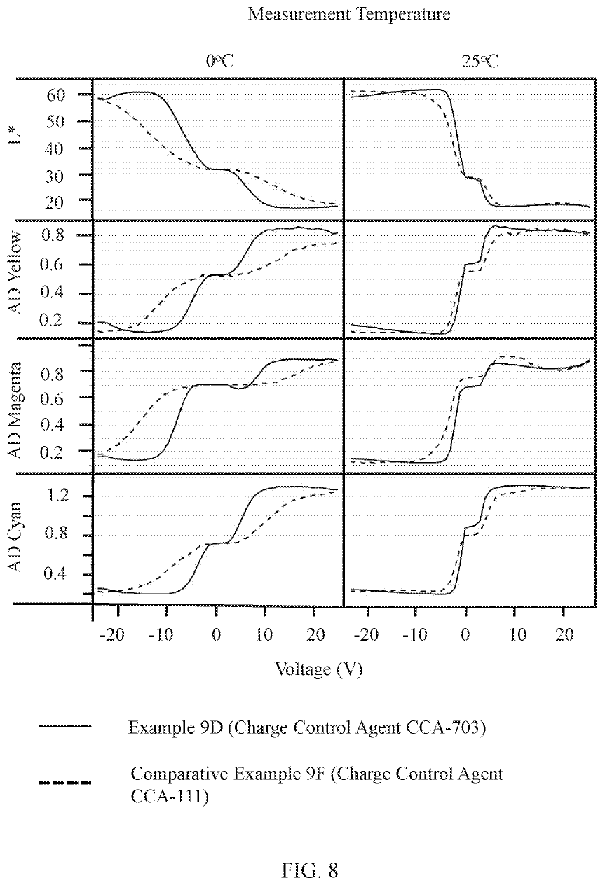

Electro-optic displays of Example 9D and Comparative Example 9F were exposed to a driving voltage sweep of from +24 V to −24 V over 500 milliseconds at 0 °C that provides change in the color state of the display. The reflected lightness L* and the reflected optical densities of cyan, magenta, and yellow were measured via a color computer at time of 0 s and every approximately 80 milliseconds during the voltage sweep. The corresponding optical densities were also converted to “analytical densities” (ad), i.e., contributions to the observed absorption spectrum of each colored pigment. The greater the value of ad, the more ideal the corresponding color is. The voltage sweep measurement was repeated for the same displays at 25 °C. The results of the voltage sweep measurements at both temperatures are provided in FIG. 8. The electro-optic display comprising the inventive charge control agent CCA-703 exhibits faster switching between optical states than displays comprising the comparative charge control agent CCA-111, as indicated by the steeper curve slopes.

### Color Gamut Measurement Method

Electro-optic displays were electrically driven to generate eight optical states (white, yellow, red, magenta, blue, cyan, green, and black). The method for the determination of the color gamut of a color electro-optic display involves that application of a waveform, which is application of a series of “dipoles”, i.e., pairs of square pulses of opposite polarity, whose duration and magnitude are systematically varied. Each dipole is composed of two monopoles, each being a pulse of length t and magnitude V. An example of a dipole (part of the series of dipoles) is provided in FIG. 9. Typically, a series of five to ten positive-negative voltage magnitudes are explored, each of which has pulse duration from 20 to 500 ms. For every voltage pair (+,−), every pulse duration is visited once. An example of a waveform may include explored voltages of +/−3.5V, +/−6.1V, +/−9.4V, +/−13.4V, +/−18.2V, +/−23.7V, and +/−30V. The reflection spectra are obtained throughout the waveform and converted to CIEL*a*b* units. The color gamut of the display was measured by computing the volume of the convex hull containing every colored state produced by the set of the testing waveform. The color gamut is reported in DE³ units. Broader color gamut, that is, larger space, means better electro-optic performance of the electrophoretic display.

### Determination of Contrast Ratio

Contrast Ratio of a display is determined as the difference between the lightness L* of the white state and the lightness L* of the darkest state of the display.

### Example 11: Color Gamuts at Two Different Temperatures

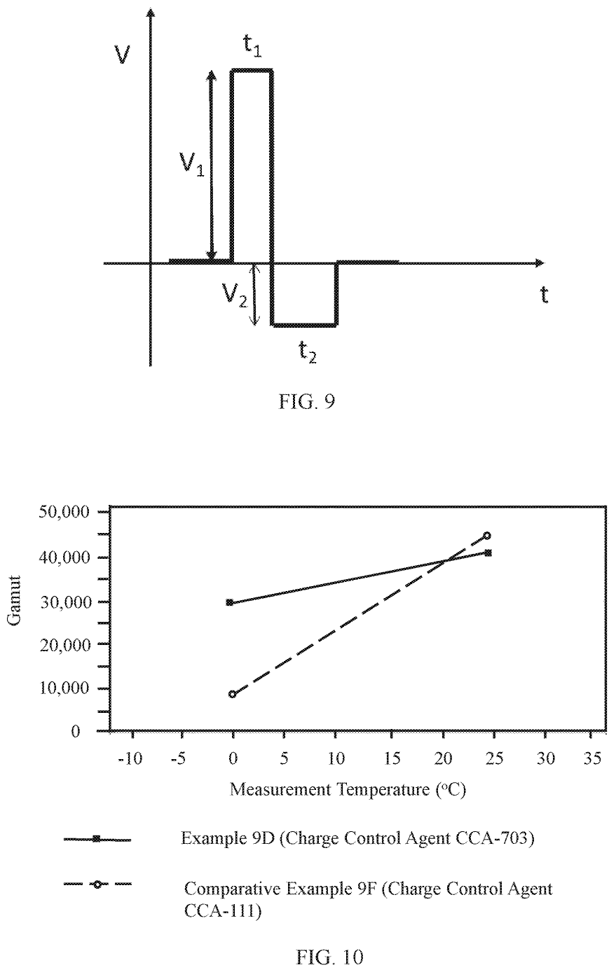

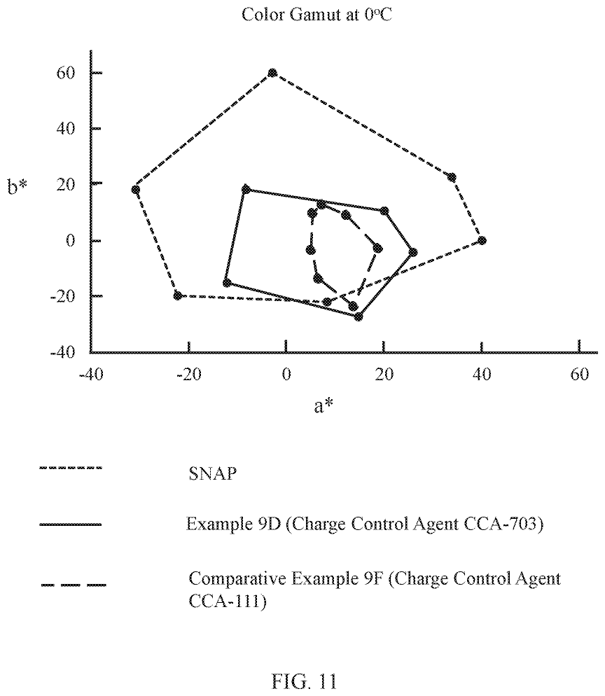

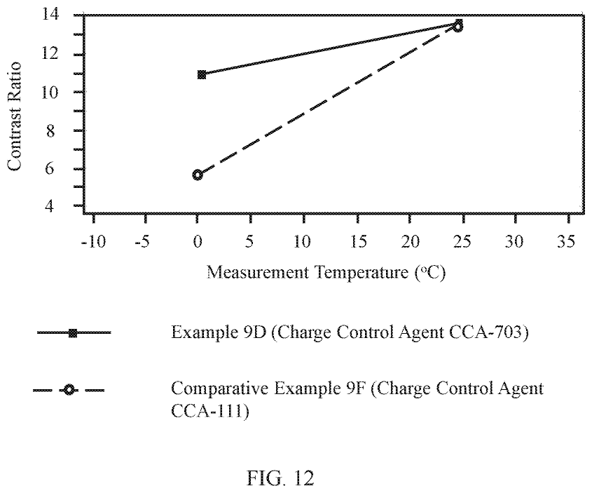

The color gamut of electro-optic displays from Comparative Example 9F comprising charge control agent CCA-111 (from Comparative Ex. 8), and Example 9D comprising charge control agent CCA-703 (from Ex. 6), were measured according to the method described above at 0 °C and 25 °C. The result of these measurements are provided in the graphs of FIG. 10. The graphs shows that the color gamut of inventive Example 9D at 0 °C is higher than the color gamut of Comparative Example 9F, whereas the color gamuts of both displays at 25 °C are similar. The graph of FIG. 11 shows the color gamut volumes of electro-optic displays from Comparative Example 9F and Example 9D at 0 °C. It is clear from FIG. 11 that the color gamut of Example 9D is larger than the color gamut of Comparative Example 9F. The graph of FIG. 11 also includes the color gamut of a standard labelled SNAP. The SNAP standard (standard for newspaper advertising production) specifies L*, a* and b* values for each of the primary colors. Hereinafter, “primary colors” refer to the eight colors, black, white, the three subtractive primaries and the three additive primaries.

### Example 12: Determination of Contrast Ratio at Two Different Temperatures

The contrast ratio of electro-optic displays from Comparative Example 9F comprising charge control agent CCA-111 (from Comparative Ex. 8), and Example 9D comprising charge control agent CCA-703 (from Ex. 6), were determined as described above at 0 °C and 25 °C. The result of these measurements are provided in the graphs of FIG. 12. The graphs shows that the contrast ratio of inventive Example 9D at 0 °C is larger than the contrast ratio of Comparative Example 9F, whereas the color gamuts of both displays at 25 °C are similar.

### Example 13: Determination of Switching Speed of Electro-Optic Displays (Comparative Ex. 9A Versus Ex. 9B and Ex. 9G)

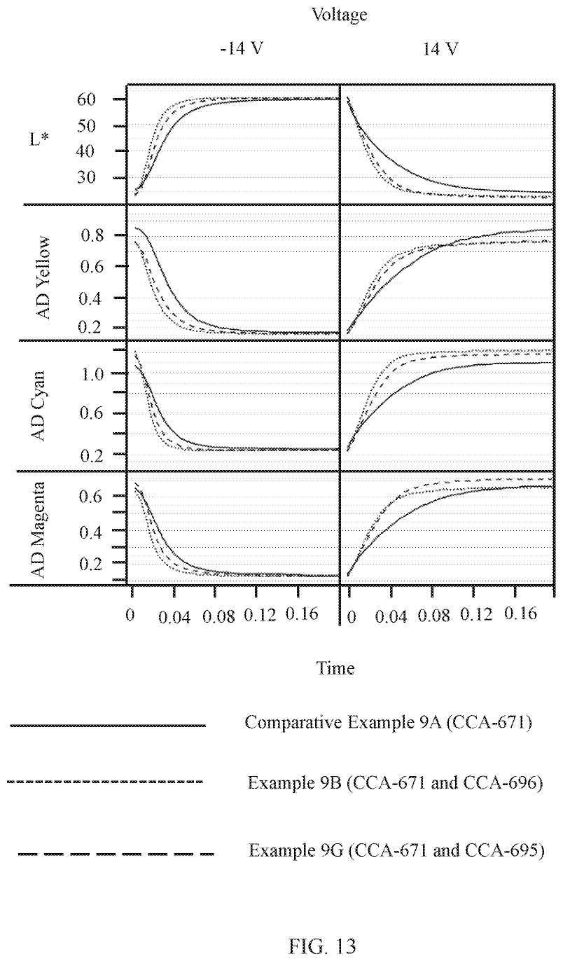

The switching speed of electro-optic displays from Comparative Example 9A comprising charge control agent CCA-671 (from Ex. 1), Example 9B comprising charge control agent CCA-696 (from Ex. 3), and Example 9G comprising a combination of CCA-671 (from Ex. 1) and CCA-695 (from Ex. 2) as weight ratio of 1:1 were determined at 25 °C as described in Example 10 above. The applied waveform includes voltages of −14 V and 14 V. The result are provided in the graphs of FIG. 13, which show that the switching speed of inventive Example 9B and 9G shows faster switching speed (steeper curve slopes) than Comparative Example 9A.

### Example 14: Determination of Switching Speed of Electro-Optic Displays (Comparative Ex. 9H Versus Ex. 91 and Ex. 9J)

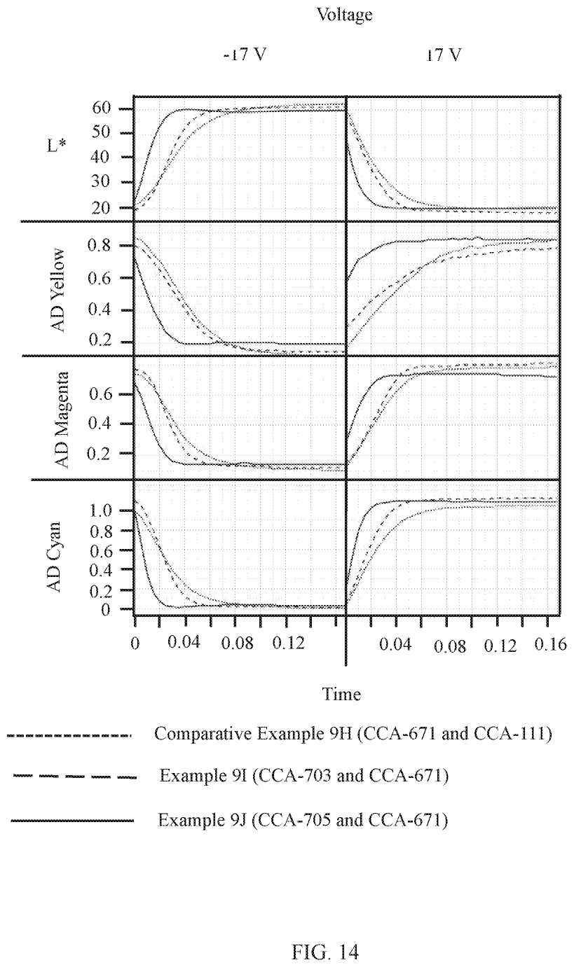

The switching speed of electro-optic displays from Comparative Example 9H comprising a combination of charge control agents CCA-111 and CCA-671, Example 91 comprising a combination of charge control agents CCA-703 and CCA-671, and Example 9J comprising a combination of CCA-705 and CCA-671 were determined at 25 °C as described in Example 10 above. The applied waveform includes voltages of −17 V and 17 V. The result are provided in the graphs of FIG. 14, which show that the switching speed of inventive Examples 9I and 9J shows faster switching speed than Comparative Example 9H. In addition, FIG. 14 shows that an electrophoretic medium that comprises a combination of three material such as (i) a first charge control agent having at least one amine oxide functional group and at least one hydrophobic moiety (CCA-703; first CCA), (ii) a second charge control agent having an amine functional group and a hydrophobic moiety (CCA-671; second CCA), and (iii) a protic acid, control agent switches faster (steeper curve slopes) than an electrophoretic medium that contains (i) and (ii), but not (iii).

### Clauses

Clause 1: An electrophoretic medium comprising a plurality of a first type of electrically charged pigment particles, a second type of electrically charged pigment particles, a first charge control agent, and a non-polar liquid, the first charge control agent having at least one amine oxide functional group and at least one hydrophobic moiety, the first type of electrically charge pigment particles having a first color and a first charged polarity, the second type of electrically charge pigment particles having a second color and a second charged polarity, the first color being different from the second color, and the first charge polarity being opposite to the second charge polarity, wherein the plurality of the first and second type of electrically charged pigment particles are capable of moving through the non-polar liquid upon application of an electric field.

Clause 2: The electrophoretic medium of clause 1, wherein the at least one hydrophobic moiety is selected from the group consisting of a hydrocarbon group, a polyester, a polythioester, a polyether, a polyamide, a polyurethane, a polyurea, a polyacrylate, a polymethacrylate, a polydimethylsiloxane, a polycarbonate, a polystyrene, a polythiocarbonate, a polylactide, and combinations thereof.

Clause 3: The electrophoretic medium of clause 2 or clause 3, wherein the first charge control agent has weight average molecular weight from 400 g/mol to 200,000 g/mol.

Clause 4: The electrophoretic medium according to any one of clause 1 to clause 3, further comprising a protic acid, the protic acid having pKa from 5 to −16.

Clause 5: The electrophoretic medium according to any one of clause 1 to clause 4, wherein the first charge control agent is selected from the group consisting of:
(a) a branched polyethylenimine derivative, the branched polyethylenimine derivative having at least one hydrophobic moiety, the branched polyethylenimine derivative being formed from a branched polyethylenimine by a first reaction, a second reaction, and a third reaction, the branched polyethylenimine having a plurality of primary amine functional groups, a plurality of secondary functional groups, and a plurality of tertiary amine functional groups, each primary amine functional group of the plurality of primary amine functional groups having a primary amine nitrogen atom, each secondary amine functional group of the plurality of secondary amine functional groups having a secondary amine nitrogen atom, each tertiary amine functional group of the plurality of tertiary amine functional groups having a tertiary amine nitrogen atom, the first reaction occurring between a first reagent and at least one primary amine functional group of the plurality of primary amine functional groups of the branched polyethylenimine, the first reaction forming at least one group A represented by Formula I,

—N(H)-D-L Formula I
wherein
N is a nitrogen atom derived from a primary amine functional group of the plurality of primary amine functional groups of the branched polyethylenimine prior to the first reaction of the branched polyethylenimine with the first reagent,
D is a moiety comprising a polar functional group, and
L is a hydrophobic moiety, the hydrophobic moiety L comprising 16 or more carbon atoms,
the second reaction occurring between the first reagent and at least one secondary amine functional group of the plurality of secondary amine functional groups of the branched polyethylenimine, the second reaction forming at least one group B represented by Formula II,

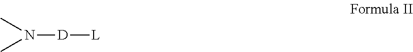

wherein
N is a nitrogen atom derived from a secondary amine functional group of the plurality of secondary amine functional groups of the branched polyethylenimine prior to the second reaction of the branched polyethylenimine with the first reagent,
D is a moiety comprising a polar functional group, and
L is a hydrophobic moiety, the hydrophobic moiety L comprising 16 or more carbon atoms,
and the third reaction occurring between a second reagent and at least one tertiary amine functional group of the plurality of tertiary amine functional groups of the branched polyethylenimine, the third reaction converting the at least one tertiary amine functional group of the plurality of tertiary amine functional groups into an amine oxide functional group, the second reagent being an oxidizing agent;
(b) a compound that is represented by Formula III; (c) a compound that is represented by Formula IV; (d) a compound that is represented by Formula V; (e) a compound that is represented by Formula VI; (f) a compound that is represented by Formula VII; (g) a compound that is represented by Formula VIII; (h) a compound that is represented by Formula IX; (i) a compound that is represented by Formula X; (j) a compound that is represented by Formula XI; (k) a compound that is represented by Formula XII; (l) a compound that is represented by Formula XIII; (m) a compound that is represented by Formula XIV; (n) a compound that is represented by Formula XV; and (o) a compound that is represented by and Formula XVI;
   wherein
R₁ is R₂₇ or R₂₈, R₂₇ being represented by Formula XVII, R₂₈ being a hydrocarbon group having a weight average molecular weight of 400 g/mol or larger,

-Q-X—R₂₉ Formula XVII,
wherein
Q is a branched or nonbranched alkanediyl group comprising from 2 to 150 carbon atoms,
X is a moiety comprising a polar functional group,
R₂₉ is a hydrophobic moiety, the hydrophobic moiety comprising 16 or more carbon atoms,
R₂, R₃, R₄, R₅, R₆, R₇, R₈, R₉, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms,
R₁₂, R₁₃, R₁₄, R₁₅, R₁₆, R₁₇, R₁₅, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms,
at least one of R₂₃ and R₂₄ being R₁,
at least one of R₁₃ and R₁₄ being a hydrophobic moiety,
at least one of R₁₇ and R₁₈ being a hydrophobic moiety,
o is 0 or 1,
R₁₁ is a biradical moiety that forms a five- or six-membered ring, the five- or six-membered ring including a nitrogen atom of an amine oxide functional group, the five- or six-membered ring having a substituent R₁₂ that is covalently bonded to a carbon atom of the five- or six-membered ring,
R₂₅ and R₂₆ are hydrophobic moieties, each hydrophobic moiety comprising 16 or more carbon atoms.

Clause 6: The electrophoretic medium of clause 5, wherein the first charge control agent is a branched polyethylenimine derivative, and wherein D of Formulas I and II is selected from the group consisting of —C(O)—, —C(O)—N(H)—, —C(O)—N(R₃₀)—, —C(O)—O—, and —C(O)—S—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

Clause 7: The electrophoretic medium of clause 5, wherein the first charge control agent is a compound that is represented by Formula III, Formula IV, Formula V, Formula VI, Formula VII, Formula VIII, Formula IX, Formula X, Formula XII, Formula XIII, Formula XIV, Formula XV, or Formula XVI, and wherein X of Formula XVII is selected from the group consisting of —O—C(O)—, —S—C(O)—, —C(O)—O—, —C(O)—S—, —N(H)—C(O)—, —N(R₃₀)—C(O)—, —C(O)—N(H)—, and —C(O)—N(R₃₀)—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

Clause 8: The electrophoretic medium of clause 5, wherein the first charge control agent is a compound that is represented by Formula III, Formula IV, Formula V, Formula VI, Formula VII, Formula VIII, Formula IX, Formula X, Formula XII, Formula XIII, Formula XIV, Formula XV, or Formula XVI, and wherein R₁ is R₂₈, wherein R₂₈ is a hydrocarbon group that contains 30 to 1000 carbon atoms.

Clause 9: The electrophoretic medium of clause 5, wherein the first charge control agent is a polyethylenimine derivative having at least one group J represented by Formula XVIII, the at least one group J being formed by a fourth reaction between a secondary nitrogen atom of the plurality of the secondary amine functional groups of the branched polyethyleneimine and a nitrogen atom of the at least one group A represented by Formula I,
wherein
N¹ is a nitrogen atom derived from a primary amine functional group of the plurality of primary amine functional groups of the branched polyethylenimine as present prior to the first and fourth reactions,
N² is a nitrogen atom derived from a secondary amine functional group of the plurality of secondary amine functional groups of the branched polyethylenimine as present prior to the fourth reaction, and
L is a hydrophobic moiety, the hydrophobic moiety L comprising 16 or more carbon atoms.

Clause 10: The electrophoretic medium of clause 5, wherein the first charge control agent is represented by Formula III, R₃ of Formula III being represented by Formula XVII, wherein Q is a branched or nonbranched alkanediyl group comprising from 2 to 150 carbon atoms, X is —O—C(O)— or —N(H)—C(O)—, and R₂₉ is a hydrophobic moiety, the hydrophobic moiety comprising 16 or more carbon atoms.

Clause 11: The electrophoretic medium of clause 10, wherein the first charge control agent is represented by Formula XIX or Formula XX.

Clause 12: The electrophoretic medium according to any one of clause 1 to clause 11 further comprising a second charge control agent, the second charge control agent having at least one hydrophobic moiety and at least one amine functional group, wherein the amine functional group is selected from the group consisting of primary, secondary, tertiary, aromatic amine functional group, and combinations thereof.

Clause 13: The electrophoretic medium of clause 12, wherein the second charge control agent is a branched polyethylenimine derivative, the branched polyethylenimine derivative having at least one hydrophobic moiety, the branched polyethylenimine derivative being formed from a branched polyethylenimine by a first reaction and a second reaction, the branched polyethylenimine having a plurality of primary amine functional groups, a plurality of secondary functional groups, and a plurality of tertiary amine functional groups, each primary amine functional group of the plurality of primary amine functional groups having a primary amine nitrogen atom, each secondary amine functional group of the plurality of secondary amine functional groups having a secondary amine nitrogen atom, each tertiary amine functional group of the plurality of tertiary amine functional groups having a tertiary amine nitrogen atom, the first reaction occurring between a first reagent and at least one primary amine functional group of the plurality of primary amine functional groups of the branched polyethylenimine, the first reaction forming at least one group A, the at least one group A represented by Formula I,

—N(H)-D-L Formula I
wherein
N is a nitrogen atom derived from a primary amine functional group of the plurality of primary amine functional groups of the branched polyethylenimine as present prior to the first reaction of the branched polyethylenimine with the first reagent,
D is a moiety comprising a polar functional group,
and L is a hydrophobic moiety, the hydrophobic moiety comprising 16 or more carbon atoms,
the second reaction occurring between the first reagent and at least one secondary amine functional group of the plurality of secondary amine functional groups of the branched polyethylenimine, the second reaction forming at least one group B represented by Formula II,

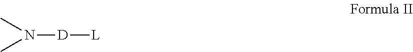

wherein
N is a nitrogen atom derived from a secondary amine functional group of the plurality of secondary amine functional groups of the branched polyethylenimine prior to the second reaction of the branched polyethylenimine with the first reagent,
D is a moiety comprising a polar functional group, and
L is a hydrophobic moiety, the hydrophobic moiety comprising 16 or more carbon atoms, and
wherein the branched polyethylenimine derivative has a plurality of primary amine functional groups, a plurality of secondary amine functional groups, and a plurality of tertiary amine functional groups.

Clause 14: The electrophoretic medium of clause 12, wherein the second charge control agent is selected from the group consisting of compounds represented by Formula XXI, Formula XXII, Formula XXIII, Formula XXIV, Formula XXV, Formula XXVI, Formula XXVII, Formula XXVIII, Formula XXIX, Formula XXX, Formula XXXI, and combinations thereof,
wherein
R₁ is R₂₇ or R₂₈, R₂₇ being represented by Formula XVII, R₂₈ being a hydrocarbon group having weight average molecular weight of 400 g/mol or larger,

-Q-X—R₂₉ Formula XVII,
wherein
Q is a branched or nonbranched alkanediyl group comprising from 2 to 150 carbon atoms,
X is a moiety comprising a polar functional group,
R₂₉ is a hydrophobic moiety, the hydrophobic moiety comprising 16 or more carbon atoms,
R₂, R₃, R₄, R₇, R₈, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms,
R₁₂, R₁₃, R₁₄, R₁₅, R₁₆, R₁₇, R₁₈, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms,
at least one of R₂₃ and R₂₄ being R₁,
at least one of R₁₃ and R₁₄ being a hydrophobic moiety,
at least one of R₁₇ and R₁₈ being a hydrophobic moiety,
o is 0 or 1,
R₁₁ is a biradical moiety that forms a five- or six-membered ring, the five- or six-membered ring including a nitrogen atom of a tertiary amine functional group, the five- or six-membered ring having substituent R₁₂ that is covalently bonded to a carbon atom of the five- or six-membered ring,
R₂₅ and R₂₆ are hydrophobic moieties, each hydrophobic moiety comprising 16 or more carbon atoms.

Clause 15: The electrophoretic medium of clause 14, wherein the second charge control agent is represented by Formula XXI, R₃ being represented by Formula XVII, wherein Q is a branched or nonbranched alkanediyl group comprising from 2 to 150 carbon atoms, X is a —O—C(O)— or —N(H)—C(O)—, and R₂₉ is a hydrophobic moiety, the hydrophobic moiety comprising 16 or more carbon atoms.

Clause 16: The electrophoretic medium of clause 15, wherein the second charge control agent is represented by Formula XXXII or Formula XXXIII.

Clause 17: The electrophoretic medium of clause 13 comprising a first charge control agent, a second charge control agent, and a protic acid, wherein the second charge control agent is a branched polyethylenimine derivative, wherein D of Formulas I and II is —C(O)—, wherein L of Formulas I and II is selected from the group consisting of poly(hydroxystearic acid), poly(ricinoleic acid), and poly(isobutylene), wherein the first charge control agent is represented by Formula XX, wherein R₂₉ is a hydrophobic moiety, the hydrophobic moiety R₂₉ comprising 16 or more carbon atoms, and wherein the protic acid has pKa from 5.0 to −5.0.

Clause 18: The electrophoretic medium of clause 17, wherein the hydrophobic moiety of R₂₉ of Formula XX is selected from the group consisting of poly(hydroxystearic acid), poly(ricinoleic acid), and poly(isobutylene).

Clause 19: The electrophoretic medium according to any one of clause 1 to clause 18, comprising a third and fourth types of electrically charged pigment particles, wherein the third type of electrically charge pigment particles has a third color and second charged polarity, the fourth type of electrically charge pigment particles has a fourth color and a third charged polarity, the first color being white, the second color being non-white, the third color being non-white and different from the second color, the fourth color being non-shite and different from the second and third colors, and the third charge polarity being the same as the first charge polarity or the opposite of the first charge polarity.

Clause 20: An electro-optic display comprising a first electrode layer, an electro-optic material layer, and a second electrode layer, the first electrode layer being light transmissive, the second electrode layer comprising a plurality of pixel electrodes, the electro-optic material layer comprising a plurality of microcapsules or a plurality of microcells, each microcapsule or microcell comprising the electrophoretic medium according to any one of clause 1 to clause 19, wherein the electro-optic material layer is disposed between the first electrode layer and the second electrode layer, and wherein the first electrode layer and the second electrode layer are configured to apply an electric field across the electro-optic material layer.

We claim:

1. An electrophoretic medium comprising a plurality of a first type of electrically charged pigment particles, a second type of electrically charged pigment particles, a first charge control agent, and a non-polar liquid, the first charge control agent having at least one amine oxide functional group and at least one hydrophobic moiety, the first type of electrically charge pigment particles having a first color and a first charged polarity, the second type of electrically charge pigment particles having a second color and a second charged polarity, the first color being different from the second color, and the first charge polarity being opposite to the second charge polarity, wherein the plurality of the first and second type of electrically charged pigment particles are capable of moving through the non-polar liquid upon application of an electric field.

2. The electrophoretic medium of claim 1, wherein the at least one hydrophobic moiety is selected from the group consisting of a hydrocarbon group, a polyester, a polythioester, a polyether, a polyamide, a polyurethane, a polyurea, a polyacrylate, a polymethacrylate, a polydimethylsiloxane, a polycarbonate, a polystyrene, a polythiocarbonate, a polylactide, and combinations thereof.

3. The electrophoretic medium of claim 1, wherein the first charge control agent has weight average molecular weight from 400 g/mol to 200,000 g/mol.

4. The electrophoretic medium of claim 1, further comprising a protic acid, the protic acid having pKa from 5 to −16.

5. The electrophoretic medium of claim 1, wherein the first charge control agent is selected from the group consisting of:
(a) a branched polyethylenimine derivative, the branched polyethylenimine derivative having at least one hydrophobic moiety, the branched polyethylenimine derivative being formed from a branched polyethylenimine by a first reaction, a second reaction, and a third reaction, the branched polyethylenimine having a plurality of primary amine functional groups, a plurality of secondary functional groups, and a plurality of tertiary amine functional groups, each primary amine functional group of the plurality of primary amine functional groups having a primary amine nitrogen atom, each secondary amine functional group of the plurality of secondary amine functional groups having a secondary amine nitrogen atom, each tertiary amine functional group of the plurality of tertiary amine functional groups having a tertiary amine nitrogen atom,
the first reaction occurring between a first reagent and at least one primary amine functional group of the plurality of primary amine functional groups of the branched polyethylenimine, the first reaction forming at least one group A represented by Formula I,
—N(H)-D-L Formula I
wherein
N is a nitrogen atom derived from a primary amine functional group of the plurality of primary amine functional groups of the branched polyethylenimine prior to the first reaction of the branched polyethylenimine with the first reagent,
D is a moiety comprising a polar functional group, and
L is a hydrophobic moiety, the hydrophobic moiety L comprising 16 or more carbon atoms,
the second reaction occurring between the first reagent and at least one secondary amine functional group of the plurality of secondary amine functional groups of the branched polyethylenimine, the second reaction forming at least one group B represented by Formula II, 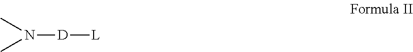
wherein
N is a nitrogen atom derived from a secondary amine functional group of the plurality of secondary amine functional groups of the branched polyethylenimine prior to the second reaction of the branched polyethylenimine with the first reagent,
D is a moiety comprising a polar functional group, and
L is a hydrophobic moiety, the hydrophobic moiety L comprising 16 or more carbon atoms,
and the third reaction occurring between a second reagent and at least one tertiary amine functional group of the plurality of tertiary amine functional groups of the branched polyethylenimine, the third reaction converting the at least one tertiary amine functional group of the plurality of tertiary amine functional groups into an amine oxide functional group, the second reagent being an oxidizing agent;
(b) a compound that is represented by Formula III; (c) a compound that is represented by Formula IV; (d) a compound that is represented by Formula V; (e) a compound that is represented by Formula VI; (f) a compound that is represented by Formula VII; (g) a compound that is represented by Formula VIII; (h) a compound that is represented by Formula IX; (i) a compound that is represented by Formula X; (j) a compound that is represented by Formula XI; (k) a compound that is represented by Formula XII; (l) a compound that is represented by Formula XIII; (m) a compound that is represented by Formula XIV; (n) a compound that is represented by Formula XV; and (o) a compound that is represented by and Formula XVI; 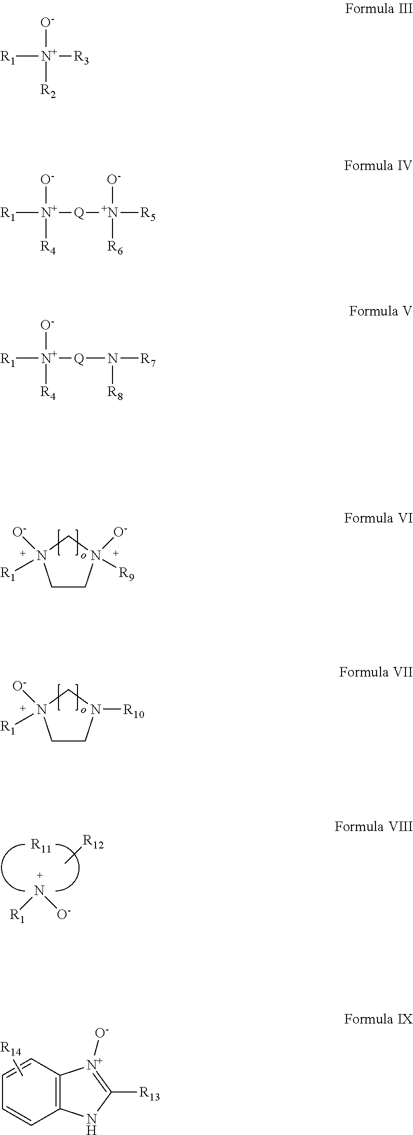 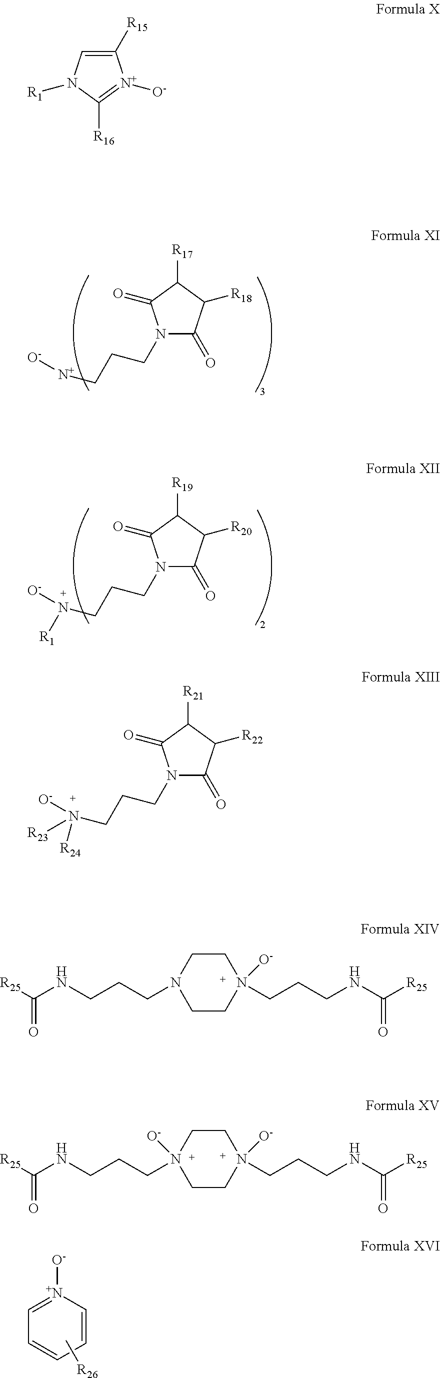
wherein
R₁ is R₂₇ or R₂₈, R₂₇ being represented by Formula XVII, R₂₈ being a hydrocarbon group having a weight average molecular weight of 400 g/mol or larger,
-Q-X—R₂₉ Formula XVII,
wherein
Q is a branched or nonbranched alkanediyl group comprising from 2 to 150 carbon atoms,
X is a moiety comprising a polar functional group,
R₂₉ is a hydrophobic moiety, the hydrophobic moiety comprising 16 or more carbon atoms,
R₂, R₃, R₄, R₅, R₆, R₇, R₈, R₉, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms,
R₁₂, R₁₃, R₁₄, R₁₅, R₁₆, R₁₇, R₁₈, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms,
at least one of R₂₃ and R₂₄ being R₁,
at least one of R₁₃ and R₁₄ being a hydrophobic moiety,
at least one of R₁₇ and R₁₈ being a hydrophobic moiety,
o is 0 or 1,
R₁₁ is a biradical moiety that forms a five- or six-membered ring, the five- or six-membered ring including a nitrogen atom of an amine oxide functional group, the five- or six-membered ring having a substituent R₁₂ that is covalently bonded to a carbon atom of the five- or six-membered ring,
R₂₅ and R₂₆ are hydrophobic moieties, each hydrophobic moiety comprising 16 or more carbon atoms.

6. The electrophoretic medium of claim 5, wherein the first charge control agent is a branched polyethylenimine derivative, and wherein D of Formulas I and II is selected from the group consisting of —C(O)—, —C(O)—N(H)—, —C(O)—N(R₃₀)—, —C(O)—O—, and —C(O)—S—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

7. The electrophoretic medium of claim 5, wherein the first charge control agent is a compound that is represented by Formula III, Formula IV, Formula V, Formula VI, Formula VII, Formula VIII, Formula IX, Formula X, Formula XII, Formula XIII, Formula XIV, Formula XV, or Formula XVI, and wherein X of Formulas XVII is selected from the group consisting of —O—C(O)—, —S—C(O)—, —C(O)—O—, C(O)—S—, —N(H)—C(O)—, —N(R₃₀)—C(O)—, —C(O)—N(H)—, and —C(O)—N(R₃₀)—, where R₃₀ is selected from a group consisting of an alkyl group, an alkenyl group, an alkynyl group, an aryl group, a benzyl group, and combination thereof, the alkyl group comprising from 1 to 20 carbon atoms, the alkenyl group comprising from 3 to 20 carbon atoms, the alkynyl group comprising from 3 to 20 carbon atoms, the aryl group comprising from 6 to 20 carbon atoms.

8. The electrophoretic medium of claim 5, wherein the first charge control agent is a compound that is represented by Formula III, Formula IV, Formula V, Formula VI, Formula VII, Formula VIII, Formula IX, Formula X, Formula XII, Formula XIII, Formula XIV, Formula XV, or Formula XVI, and wherein R₁ is R₂₈, wherein R₂₈ is a hydrocarbon group that contains 30 to 1000 carbon atoms.

9. The electrophoretic medium of claim 5, wherein the first charge control agent is a polyethylenimine derivative having at least one group J represented by Formula XVIII, the at least one group J being formed by a fourth reaction between a secondary nitrogen atom of the plurality of the secondary amine functional groups of the branched polyethyleneimine and a nitrogen atom of the at least one group A represented by Formula I, wherein D of Formula I is —C(O)—, 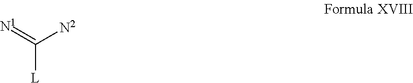
wherein
N¹ is a nitrogen atom derived from a primary amine functional group of the plurality of primary amine functional groups of the branched polyethylenimine as present prior to the first and fourth reactions,
N² is a nitrogen atom derived from a secondary amine functional group of the plurality of secondary amine functional groups of the branched polyethylenimine as present prior to the fourth reaction, and
L is a hydrophobic moiety, the hydrophobic moiety L comprising 16 or more carbon atoms.

10. The electrophoretic medium of claim 5, wherein the first charge control agent is represented by Formula III, R₃ of Formula III being represented by Formula XVII, wherein Q is a branched or nonbranched alkanediyl group comprising from 2 to 150 carbon atoms, X is a —O—C(O)— or —N(H)—C(O)—, and R₂₉ is a hydrophobic moiety, the hydrophobic moiety comprising 16 or more carbon atoms.

11. The electrophoretic medium of claim 10, wherein the first charge control agent is represented by Formula XIX or Formula XX.

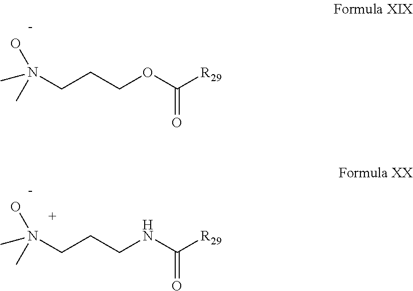

12. The electrophoretic medium of claim 1 further comprising a second charge control agent, the second charge control agent having at least one hydrophobic moiety and at least one amine functional group, wherein the amine functional group is selected from the group consisting of primary, secondary, tertiary, aromatic amine functional group, and combinations thereof.

13. The electrophoretic medium of claim 12, wherein the second charge control agent is a branched polyethylenimine derivative, the branched polyethylenimine derivative having at least one hydrophobic moiety, the branched polyethylenimine derivative being formed from a branched polyethylenimine by a first reaction and a second reaction, the branched polyethylenimine having a plurality of primary amine functional groups, a plurality of secondary functional groups, and a plurality of tertiary amine functional groups, each primary amine functional group of the plurality of primary amine functional groups having a primary amine nitrogen atom, each secondary amine functional group of the plurality of secondary amine functional groups having a secondary amine nitrogen atom, each tertiary amine functional group of the plurality of tertiary amine functional groups having a tertiary amine nitrogen atom, the first reaction occurring between a first reagent and at least one primary amine functional group of the plurality of primary amine functional groups of the branched polyethylenimine, the first reaction forming at least one group A, the at least one group A represented by Formula I,
—N(H)-D-L Formula I
wherein
N is a nitrogen atom derived from a primary amine functional group of the plurality of primary amine functional groups of the branched polyethylenimine as present prior to the first reaction of the branched polyethylenimine with the first reagent,
D is a moiety comprising a polar functional group,
and L is a hydrophobic moiety, the hydrophobic moiety comprising 16 or more carbon atoms,
the second reaction occurring between the first reagent and at least one secondary amine functional group of the plurality of secondary amine functional groups of the branched polyethylenimine, the second reaction forming at least one group B represented by Formula II, 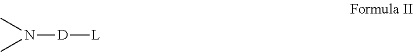
wherein
N is a nitrogen atom derived from a secondary amine functional group of the plurality of secondary amine functional groups of the branched polyethylenimine prior to the second reaction of the branched polyethylenimine with the first reagent,
D is a moiety comprising a polar functional group, and
L is a hydrophobic moiety, the hydrophobic moiety comprising 16 or more carbon atoms, and
wherein the branched polyethylenimine derivative has a plurality of primary amine functional groups, a plurality of secondary amine functional groups, and a plurality of tertiary amine functional groups.

14. The electrophoretic medium of claim 12, wherein the second charge control agent is selected from the group consisting of compounds represented by Formula XXI, Formula XXII, Formula XXIII, Formula XXIV, Formula XXV, Formula XXVI, Formula XXVII, Formula XXVIII, Formula XXIX, Formula XXX, Formula XXXI, and combinations thereof. 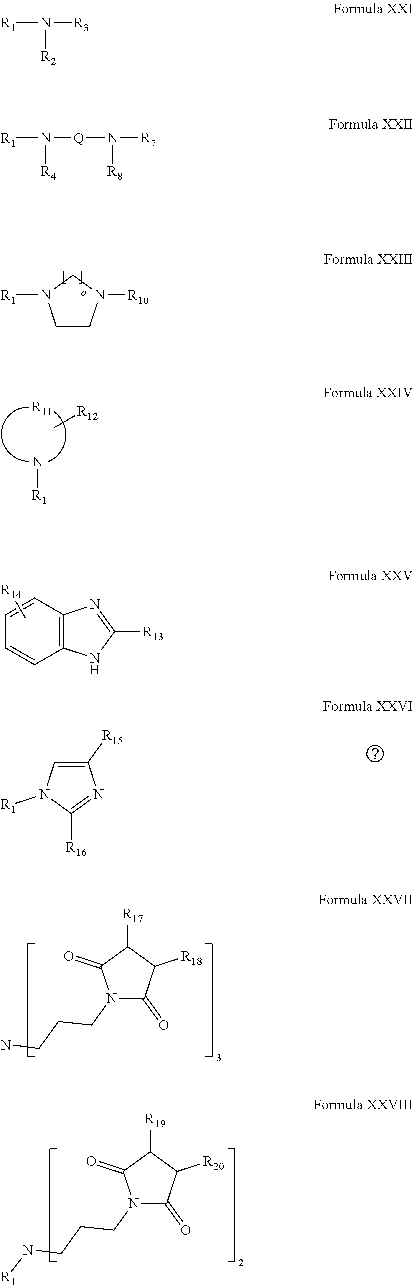 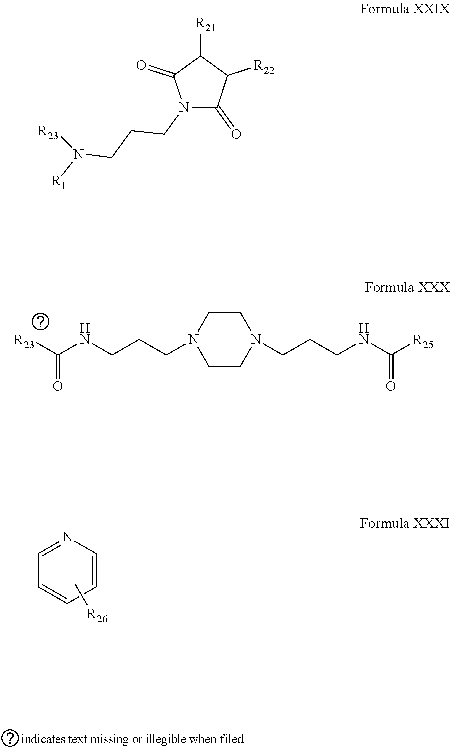
wherein
R₁ is R₂ or R₂₈, R₂₇ being represented by Formula XVII, R₂₈ being a hydrocarbon group having weight average molecular weight of 400 g/mol or larger,
rFormula XVII,
wherein
Q is a branched or nonbranched alkanediyl group comprising from 2 to 150 carbon atoms,
X is a moiety comprising a polar functional group,
R₂₉ is a hydrophobic moiety, the hydrophobic moiety comprising 16 or more carbon atoms,
R₂, R₃, R₄, R₇, R₈, R₁₀, R₂₃, R₂₄ are independently selected from the group consisting of hydrogen, an alkyl group, an alkenyl, an alkynyl group, an aryl group, and R₁, the alkyl group containing from 1 to 30 carbon atoms, the alkenyl group containing from 3 to 30 carbon atoms, the alkynyl group containing from 3 to 30 carbon atoms, the aryl group containing from 6 to 30 carbon atoms,
R₁₂, R₁₃, R₁₄, R₁₅, R₁₆, R₁₇, R₁₈, R₁₉, R₂₀, R₂₁, R₂₂ are independently selected from the group consisting of hydrogen, an alkyl group, an alkenyl, an alkynyl group, an aryl group, and a hydrophobic moiety, the alkyl group containing from 1 to 10 carbon atoms, the alkenyl group containing from 3 to 10 carbon atoms, the alkynyl group containing from 3 to 10 carbon atoms, the aryl group containing from 6 to 12 carbon atoms, the hydrophobic moiety containing 16 or more carbon atoms,
at least one of R₂₃ and R₂₄ being R₁,
at least one of R₁₃ and R₁₄ being a hydrophobic moiety,
at least one of R₁₇ and R₁₈ being a hydrophobic moiety,
o is 0 or 1, R₁₁ is a biradical moiety that forms a five- or six-membered ring, the five- or six-membered ring including a nitrogen atom of a tertiary amine functional group, the five- or six-membered ring having substituent R₁₂ that is covalently bonded to a carbon atom of the five- or six-membered ring,
R₂₅ and R₂₆ are hydrophobic moieties, each hydrophobic moiety comprising 16 or more carbon atoms.

15. The electrophoretic medium of claim 14, wherein the second charge control agent is represented by Formula XXI, R₃ being represented by Formula XVII, wherein Q is a branched or nonbranched alkanediyl group comprising from 2 to 150 carbon atoms, X is a —O—C(O)— or —N(H)—C(O)—, and R₂₉ is a hydrophobic moiety, the hydrophobic moiety comprising 16 or more carbon atoms.

16. The electrophoretic medium of claim 15, wherein the second charge control agent is represented by Formula XXXII or Formula XXXIII.

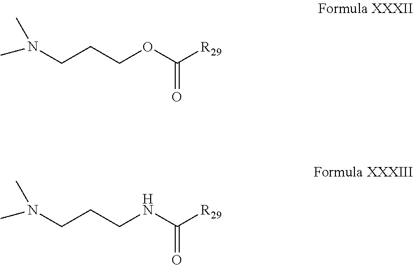

17. The electrophoretic medium of claim 13 comprising a first charge control agent, a second charge control agent, and a protic acid, wherein the second charge control agent is a branched polyethylenimine derivative, wherein D of Formulas I and II is —C(O)—, wherein L of Formulas I and II is selected from the group consisting of poly(hydroxystearic acid), poly(ricinoleic acid), and poly(isobutylene), wherein the first charge control agent is represented by Formula XX, wherein R₂₉ is a hydrophobic moiety, the hydrophobic moiety R₂₉ comprising 16 or more carbon atoms, and wherein the protic acid has pKa from 5.0 to −5.0.

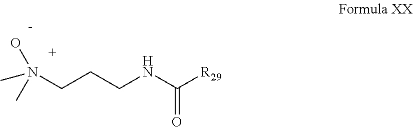

18. The electrophoretic medium of claim 17, wherein the hydrophobic moiety of R₂₉ of Formula XX is selected from the group consisting of poly(hydroxystearic acid), poly(ricinoleic acid), and poly(isobutylene).

19. The electrophoretic medium of claim 1, comprising a third and fourth types of electrically charged pigment particles, wherein the third type of electrically charge pigment particles has a third color and second charged polarity, the fourth type of electrically charge pigment particles has a fourth color and a third charged polarity, the first color being white, the second color being non-white, the third color being non-white and different from the second color, the fourth color being non-shite and different from the second and third colors, and the third charge polarity being the same as the first charge polarity or the opposite of the first charge polarity.

20. An electro-optic display comprising a first electrode layer, an electro-optic material layer, and a second electrode layer, the first electrode layer being light transmissive, the second electrode layer comprising a plurality of pixel electrodes, the electro-optic material layer comprising a plurality of microcapsules or a plurality of microcells, each microcapsule or microcell comprising the electrophoretic medium of claim 1, wherein the electro-optic material layer is disposed between the first electrode layer and the second electrode layer, and wherein the first electrode layer and the second electrode layer are configured to apply an electric field across the electro-optic material layer.
